(19) United States
(12) Patent Application Publication
(10) Pub. No.: US 2021/0243839 A1
(43) Pub. Date: Aug. 5, 2021

(54) DATA ANALYSIS AND CONFIGURATION OF A DISTRIBUTED RADIO ACCESS NETWORK

(71) Applicant: CommScope Technologies LLC, Hickory, NC (US)

(72) Inventors: Vijayaraghavan Krishnaswamy, Bengaluru (IN); Pavan Kulkarni, Bangalore (IN); Kesava Rao Vetapalem, Bengaluru (IN); Swami Rangaiah Damerla, Giddalur (IN); Prashant D Paraddi, Bangalore (IN)

(73) Assignee: CommScope Technologies LLC, Hickory, NC (US)

(21) Appl. No.: 17/150,290

(22) Filed: Jan. 15, 2021

Related U.S. Application Data
(60) Provisional application No. 62/969,929, filed on Feb. 4, 2020.

(51) Int. Cl. H04W 88/08; H04W 72/04; H04L 5/00; H04W 76/27; H04W 74/08; H04W 24/04; H04W 24/10

(52) U.S. Cl. CPC H04W 88/085; H04W 72/042; H04L 5/0048; H04W 24/10; H04W 74/08; H04W 24/04; H04W 76/27

(57) ABSTRACT

A distributed radio access network (RAN) includes a plurality of remote units (RUs), each being configured to exchange RF signals with at least one UE. The distributed RAN also includes a central unit communicatively coupled to the plurality of RUs via a fronthaul and/or midhaul network comprising one or more ethernet switches. The distributed RAN also includes at least one processor configured to receive diagnostic information relating at least to processing performed for at least two layers of a network and/or air interface implemented by the distributed RAN; identify a system performance problem based on the diagnostic information; search for a cause of the system performance problem using at least a portion of the diagnostic information; and when the cause of the system performance problem is identified using the at least a portion of the diagnostic information, determine at least one action to correct, limit, or circumvent the system performance problem.

### CROSS-REFERENCE TO RELATED APPLICATIONS

This application claims the benefit of U.S. Provisional Patent Application Ser.

No. 62/969,929 (Attorney Docket 4456 US P1/100.1900USPR) filed on Feb. 4, 2020, entitled “DATA ANALYSIS AND CONFIGURATION OF A DISTRIBUTED RADIO ACCESS NETWORK”, the entirety of which is incorporated herein by reference.

### BACKGROUND

In a distributed radio access network (RAN), geographically-separate remote units are controlled by a centralized unit and provide wireless service to nearby user equipment (UEs). In a distributed RAN, such as a cloud RAN (C-RAN), there are multiple possible points of failure. Furthermore, different deployments may vary from each other. It is desirable to be able to collect diagnostic information, diagnose problems, and/or make changes to parameters or the network configuration to address the problems in a distributed RAN in a real-time (or near real-time) manner.

### SUMMARY

A distributed radio access network (RAN) includes a plurality of remote units (RUs), each being configured to exchange RF signals with at least one UE. The distributed RAN also includes a central unit communicatively coupled to the plurality of RUs via a fronthaul and/or midhaul network comprising one or more ethernet switches. The distributed RAN also includes at least one processor configured to receive diagnostic information relating at least to processing performed for at least two layers of a network and/or air interface implemented by the distributed RAN; identify a system performance problem based on the diagnostic information; search for a cause of the system performance problem using at least a portion of the diagnostic information; and when the cause of the system performance problem is identified using the at least a portion of the diagnostic information, determine at least one action to correct, limit, or circumvent the system performance problem.

### DRAWINGS

Understanding that the drawings depict only exemplary configurations and are not therefore to be considered limiting in scope, the exemplary configurations will be described with additional specificity and detail through the use of the accompanying drawings, in which:

FIG. 1A is a block diagram illustrating an exemplary configuration of a system implementing data analysis and/or configuration of a C-RAN;

FIG. 1B is a block diagram illustrating another exemplary configuration of a system implementing data analysis and/or configuration of a C-RAN;

FIG. 2 is a block diagram illustrating example inputs and outputs to a PRANmon component in a distributed radio access network (RAN);

FIG. 3 is a flow diagram illustrating an example method for data analysis and configuring a cloud radio access network (C-RAN);

FIG. 4 is a flow diagram illustrating a method for data analysis and configuration of a distributed RAN;

FIG. 5 is a sequence diagram illustrating a key performance indicator (KPI) debugging scenario;

FIG. 6 is a sequence diagram illustrating various points where additional action could be taken by a target eNodeB (eNB) to debug hand-in failures;

FIG. 7 is an additional sequence diagram illustrating various points where additional action could be taken by a source eNB to debug hand-in failures;

FIG. 8 is a sequence diagram illustrating various points where additional action could be taken to debug system performance issues in the fronthaul network (FH) of a C-RAN; and

FIG. 9 is a sequence diagram illustrating action that could be taken to debug semi-persistent scheduling (SPS) issues in a communication system.

In accordance with common practice, the various described features are not drawn to scale but are drawn to emphasize specific features relevant to the exemplary configurations.

### DETAILED DESCRIPTION

In a typical Third Generation Partnership Project (3GPP) Fourth Generation (4G) C-RAN, there are multiple devices (e.g., baseband controller unit(s), radio units (RUs), RF units (antenna arrays)) interfaced together to enable and implement RAN functions. In a typical 3GPP Fifth Generation (5G) C-RAN, there may be further logical and/or physical splits in the devices (e.g., centralized unit(s) (CU(s)), distributed unit(s) (DU(s)), radio units (RUs), RF units (antenna arrays)), which are interfaced together to enable and implement RAN functions.

These networks may also include multiple switches and/or routers in a fronthaul network that connects the various devices. The behavior and implementation of these switches and/or routers may vary from each other because they are sourced from different vendors and have different capabilities, configurations, and/or functionalities.

In each of these devices, there are several protocol components that interface with each other to achieve the desired RAN function. As used herein, a “component” may be a set of instructions that implements particular functionality when executed by a processor. Each device in a distributed RAN may include one or more components. For example, a device may have at least one component to implement L1 functionality, at least one component to implement L2 functionality, at least one component to implement L3 functionality, etc. In contrast, the term “element” (e.g., network element) is generally, and without limitation, synonymous with the term “device”.

A 4G baseband controller unit typically uses multiple LTE control plane protocols (e.g., Stream Control Transmission Protocol (SCTP), S1 Application Protocol (S1AP)/X2 Application Protocol (X2AP), Radio Resource Control (RRC), etc.) and several lower-layer protocols, such as Radio Link Control (RLC), Medium Access Control (MAC), etc. A 4G baseband controller unit may also implement several baseband components like upper Layer-1 (L1), which implements several physical layer channels encoding/decoding functions; and/or lower-L1, which implements inverse Fast Fourier Transform (iFFT)/Fast Fourier Transform (FFT) and such other signal transformation functions. The interface between the layers are reasonably defined and they are exchanged using inter-process, inter-node messaging protocols and schemes.

Because of the nature and focus of these protocol implementations, the various protocol components generally end up operating in silos with one protocol layer not knowing what other protocol layer is going through with respect to its view of UEs, messaging load, performance, error-scenarios, etc. Accordingly, additional protocol information is captured from different messaging schemes to debug such inter-component issues, e.g., S1-messaging, FAPI-messaging, L2-L3 protocol messages, L2/L3-OAM messaging, CU-RU I/O-messaging, RU-FPGA protocol etc. However, this messaging information is difficult to capture and sometimes captures excess amounts of data, which can, by itself, impact the system performance. Additionally, this type of long-duration, time-synchronized capture of these different inter-component messaging requires non-trivial effort. This also captures large volumes of data and can impact analysis times and turnaround times for the issue resolution.

Furthermore, failures on one component can provide detailed symptoms about an impending issue but is not practical to make changes to network parameters and/or the network configuration because there's no controlling/integrating component that assists in decision-making across different-components. Accordingly, single-component diagnostic information may additionally require offline analysis of logs, while system functionality is severely impaired. Changing network parameters and/or the network configuration can include resetting devices, enabling or disabling features, reducing capacity limits, restricting user-access, triggering a load-shedding action, etc.

Additionally, the design of the protocol-messaging layers is generic and typically not context-aware. At certain times, some specific scenarios/failures are known to occur repeatedly. Such occurrence needs to be ignored during the transient conditions, while tracking other key performance indicators (KPIs). KPIs can be any metric or indication of system performance in a distributed RAN. Without limitation, various cell/sector throughput and data volume KPIs, accessibility and retainability KPIs, handover KPIs, resource utilization KPIs, channel quality KPIs, Voice-over-LTE (VoLTE) and Circuit-Switched Fallback (CSFB) KPIs, smart reuse KPIs, X2 KPIs, and/or carrier aggregation KPIs may be tracked in a distributed RAN. As an example, specific accessibility and retainability KPIs are listed in Table 1 below. As used herein, “smart reuse” refers to the same frequency resource(s) being used for a multiple sets of UEs, each set of UEs being under a different, geographically diverse set of RUs.

TABLE 1

| KPI | | |
|---|---|---|
| Type/Group | KPI Name | KPI Description |
| Accessibility | E-UTRAN | Probability success rate for initial |
| and | Radio Access | E-RABs establishment. Successful |
| Retainability | Bearer | attempts compared with total |
| | (E-RAB) | number of attempts for the different |
| | Accessibility % | parts of the E-RAB establishment. |
| | Connection Drop | The percentage of connection drops |
| | Rate % | (times when UE context is released |
| | | due to abnormal reasons divided by |
| | | the total number of times the UE |
| | | context was released successfully) |
| | RRC Re-Est | This is a measure of RRC re- |
| | Attempt Rate % | establishment attempts (includes |
| | | attempts due to radio link failure |
| | | (RLF), reconfiguration failures, |
| | | handover failures etc.) in the |
| | | system. It is the ratio of the total |
| | | number of RRC connection re- |
| | | establishment request received by |
| | | the eNB to the total number of |
| | | successfully setup RRC |
| | | connections and re-establishments |
| | | in the measurement period. |
| | RRC Connection | Percentage of times when an RRC |
| | Failure Rate % | connection request was received |
| | | but RRC connection setup complete |
| | | was not received by the eNB. |
| | Avg. RRC | This is a measure of the time taken |
| | Connection | to setup an RRC connection from |
| | Setup Time | the eNB's perspective. It is the |
| | (msecs) | average time delta between |
| | | receiving an RRC connection |
| | | request and RRC connection setup |
| | | complete message for those |
| | | connections that were successfully |
| | | setup by the eNB. |

The messaging components are typically unaware of repeating or transient situations because they are not context-aware. However, an audit/diagnosis system could track such scenarios and carefully avoid or ignore such instances in its performance diagnostics while watching for real performance issues. For example, if there's a misconfiguration in a neighbor C-RAN, causing faulty handover messages to the eNB, the faulty handover messages need to be ignored during transient conditions.

Thus, there's a need for an independent decision-support system in the devices of a distributed RAN, which cuts across different components and elements and has complete visibility of various protocol states, component-loads, and UE-states. The decision-support system can use this gathered information to make decisions to adapt control functions, parameters and configurations; adjust component settings; increase or decrease the frequency with which diagnostic information is measured; perform dynamic capture of additional messaging information; trigger load-balancing actions; and/or act as a central entity to communicate such information to peer RAN components.

This centralized component (which may also be referred to as a Performance of a Radio Access Network monitoring tool (PRANmon)) can perform various functions, including (1) centralized and continuous audit; (2) self-diagnosis; and (3) assisting with various performance management of devices. If necessary, it can adjust the parameters of the system to collect more and/or different data for offline analysis. It may also receive new policy information so that it can optimize parameters in the system.

### Example 4G C-RAN

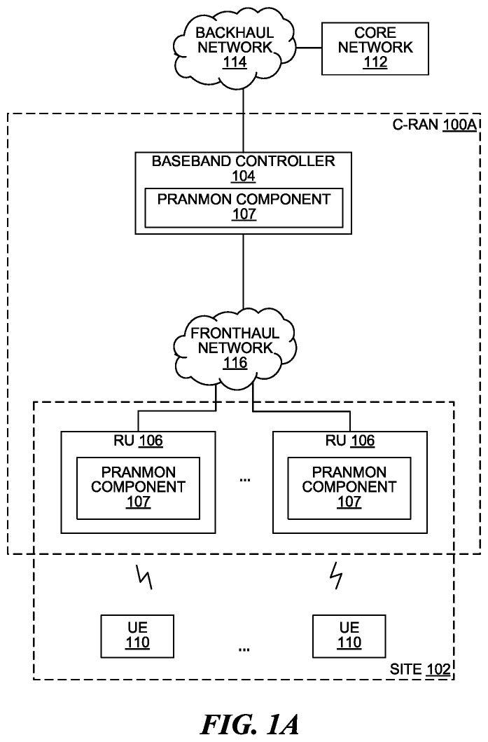

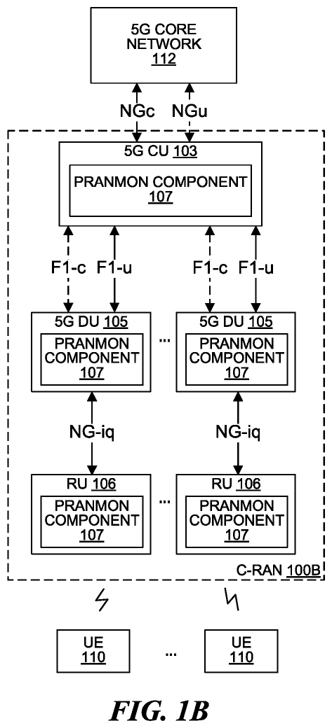

FIG. 1A is a block diagram illustrating an exemplary configuration of a communication system 100A implementing data analysis and/or configuration of a C-RAN 100A. In the exemplary configuration shown in FIG. 1A, the system 100A is implemented using the cloud radio access network (C-RAN) (point-to-multipoint distributed base station) architecture that employs at least one baseband unit 104 and one or more remote units 106, also referred to as “radio units,” “RUs,” “radio points”, or “RPs,” which serve at least one cell. It should be noted that the Figures herein are illustrated with different numbers of RUs 106, however, a C-RAN 100A can include any number of RUs 106, e.g., 2-100. In other words, the number of RUs 106 illustrated in the Figures is not meant to be limiting.

The RUs 106 may be deployed at a site 102 to provide wireless coverage and capacity for one or more wireless network operators. The site 102 may be, for example, a building or campus or other grouping of buildings (used, for example, by one or more businesses, governments, other enterprise entities) or some other public venue (such as a hotel, resort, amusement park, hospital, shopping center, airport, university campus, arena, or an outdoor area such as a ski area, stadium or a densely-populated downtown area). In some configurations, the site 102 is at least partially (and optionally entirely) indoors, but other alternatives are possible.

The system 100A may also be referred to here as a “C-RAN” or a “C-RAN system.” The baseband unit 104 is one type of central unit, and is also referred to here as “baseband controller” 104, or just “controller” 104. Each radio unit (RU) 106 may include or be coupled to at least one antenna used to radiate downlink RF signals to user equipment (UEs) 110 and receive uplink RF signals transmitted by UEs 110. The baseband controller 104 may optionally be physically located remotely from the site 102, e.g., in a centralized bank of baseband controllers 104. Additionally, the RUs 106 may be physically separated from each other within the site 102, although they are each communicatively coupled to the baseband controller 104 via a fronthaul network 116 (or just “fronthaul”). Communication relating to L1 functions generally relies on the fronthaul network 116 interface.

Each UE 110 may be a computing device with at least one processor that executes instructions stored in memory, e.g., a mobile phone, tablet computer, mobile media device, mobile gaming device, laptop computer, vehicle-based computer, a desktop computer, etc. Each baseband controller 104 and RU 106 may be a computing device with at least one processor that executes instructions stored in memory. Furthermore, each RU 106 may optionally implement one or more instances of a radio unit 106.

The C-RAN 100A may optionally implement frequency reuse where the same frequency resource(s) are used for multiple sets of UEs 110, each set of UEs 110 being under a different, geographically diverse set of RUs 106.

The system 100A is coupled to a core network 112 of each wireless network operator over an appropriate backhaul network 114. For example, the Internet may be used for backhaul 114 between the system 100A and each core network 112. However, it is understood that the backhaul network 114 can be implemented in other ways. Communication relating to L3 functions generally relies on the backhaul network 114 interface. Each of the backhaul network 114 and/or the fronthaul network 116 described herein may be implemented with one or more network elements, such as switches, routers, and/or other networking devices. For example, the backhaul network 114 and/or the fronthaul network 116 may be implemented as a switched ETHERNET network.

The system 100A may be implemented as a Long Term Evolution (LTE) radio access network providing wireless service using the LTE air interface. LTE is a standard developed by the 3GPP standards organization. In this configuration, the baseband controller 104 and RUs 106 together are used to implement an LTE Evolved Node B (also referred to here as an “eNodeB” or “eNB”). An eNB may be used to provide UEs 110 with mobile access to the wireless network operator's core network 112 to enable UEs 110 to wirelessly communicate data and voice (using, for example, Voice over LTE (VoLTE) technology). However, it should be noted that the present systems and methods may be used with other wireless protocols, e.g., the system 100A may be implemented as a 3GPP 5G RAN providing wireless service using a 5G air interface, as described below.

Also, in an exemplary LTE configuration, each core network 112 may be implemented as an Evolved Packet Core (EPC) 112 comprising standard LTE EPC network devices such as, for example, a mobility management entity (MME) and a Serving Gateway (SGW) and, optionally, a Home eNB gateway (HeNB GW) (not shown) and a Security Gateway (SeGW or SecGW) (not shown).

Moreover, in an exemplary LTE configuration, each baseband controller 104 may communicate with the MME and SGW in the EPC core network 112 using the LTE S1 interface and communicates with eNBs using the LTE X2 interface. For example, the baseband controller 104 can communicate with an outdoor macro eNB (not shown) via the LTE X2 interface.

Each baseband controller 104 and remote unit 106 can be implemented so as to use an air interface that supports one or more of frequency-division duplexing (FDD) and/or time-division duplexing (TDD). Also, the baseband controller 104 and the remote units 106 can be implemented to use an air interface that supports one or more of the multiple-input-multiple-output (MIMO), single-input-single-output (SISO), single-input-multiple-output (SIMO), and/or beam forming schemes. For example, the baseband controller 104 and the remote units 106 can implement one or more of the LTE transmission modes. Moreover, the baseband controller 104 and the remote units 106 can be configured to support multiple air interfaces and/or to support multiple wireless operators.

In some configurations, in-phase, quadrature-phase (I/Q) data representing pre-processed baseband symbols for the air interface is communicated between the baseband controller 104 and the RUs 106. Communicating such baseband I/Q data typically requires a relatively high data rate front haul.

In some configurations, a baseband signal can be pre-processed at a source RU 106 and converted to frequency domain signals (after removing guard band/cyclic prefix data, etc.) in order to effectively manage the fronthaul rates, before being sent to the baseband controller 104. Each RU 106 can further reduce the data rates by quantizing such frequency domain signals and reducing the number of bits used to carry such signals and sending the data. In a further simplification, certain symbol data/channel data may be fully processed in the source RU 106 itself and only the resultant information is passed to the baseband controller 104.

The Third Generation Partnership Project (3GPP) has adopted a layered model for the LTE radio access interface. Generally, some combination of the baseband controller 104 and RUs 106 perform analog radio frequency (RF) functions for the air interface as well as digital Layer 1 (L1), Layer 2 (L2), and Layer 3 (L3) (of the 3GPP-defined LTE radio access interface protocol) functions for the air interface. Any suitable split of L1-L3 processing (between the baseband controller 104 and RUs 106) may be implemented. Where baseband signal I/Q data is fronthauled between the baseband controller 104 and the RUs 106, each baseband controller 104 can be configured to perform all or some of the digital L1, L2, and L3 processing for the air interface. In this case, the L1 functions in each RU 106 is configured to implement all or some of the digital L1 processing for the air interface.

Where the fronthaul ETHERNET network 116 is not able to deliver the data rate need to front haul (uncompressed) I/Q data, the I/Q data can be compressed prior to being communicated over the ETHERNET network 116, thereby reducing the data rate needed communicate such I/Q data over the ETHERNET network 116.

Data can be fronthauled between the baseband controller 104 and RUs 106 in other ways, for example, using fronthaul interfaces and techniques specified in the Common Public Radio Interface (CPRI) and/or Open Base Station Architecture Initiative (OBSAI) family of specifications.

In some configurations, the baseband controller 104 the RU(s) 106, and/or switch(es) in the fronthaul 116 may include a PRANmon component 107, e.g., implemented as a set of instructions stored in a memory and executed by at least one processor in the respective device(s). In some configurations, the PRANmon component 107 may implement different aspects of the PRANmon functionality, depending on the device it is located in, e.g., in some configurations, the PRANmon component 107 in a baseband controller 104 may assist in making network configuration decisions (such as when to remove an RU 106 from a combining group), while the PRANmon component(s) 107 in the RU(s) 106 gather diagnostic information for the PRANmon component 107 in the baseband controller 104 to use in its decision-making. Furthermore, the PRANmon components 107 in different devices may communicate with each other. Where a PRANmon component 107 is described as performing an action, it could optionally refer to PRANmon components 107 in multiple different elements collectively performing the action.

As used herein, a “combining group” (CZV) is a group of RUs 106 (e.g., up to four) that receive and combine uplink RF signals from a particular UE 110 and/or send downlink RF signals to a particular UE 110. For example, a downlink combining group for a UE 110 may include a group of RUs 106 that transmit to the UE 110. Conversely, an uplink combining group for a UE 110 may include a group of RUs 106 that receive transmissions from the UE 110, which are combined together (e.g., using a maximum likelihood combining) into a single uplink signal.

A PRANmon component 107 may implement a set of hierarchical triggers with corresponding actions using policies. For example, a policy may use collected diagnostic information as input 120 to determine an action from a set of triggers in the policy. Each trigger can cascade into further sub-triggers, which themselves may be associated with certain actions according to a policy. Individual policies and triggers can be populated on the network device at runtime. Each output/action 124 can optionally create new inputs 120, which can be used to determine a further set of policies 122 with their own set of triggers and outputs/actions 124—in a recursive manner.

The PRANmon component 107 may collect diagnostic information that can be used to identify performance issues/problems in the C-RAN 100. This can include determining what performance metrics to collect, how frequently to collect it, and/or the device or component to collect it from. In some configurations, the PRANmon component 107 can monitor metrics and/or messaging for multiple layers of the RAN interface (e.g., L1, L2, L3, fronthaul network 116, backhaul network 114, etc.) to monitor the performance of the C-RAN 100.

The PRANmon component 107 can identify where the problem is (e.g., specific UE(s) 110, RU(s) 106, switch(es), or other components (such as L1, L2, L3), etc.), then capture information specifically for the problematic device(s) or component(s) so that the problem can be further debugged, and act to address or correct, mitigate, and/or avoid the problem. In 5G, this could include CUs 103, DUs 105, master eNBs (MeNBs), ng-eNBs, and their interfacing components.

For example, the actions taken by the PRANmon component 107 can include: adjusting parameters, configurations, or other functions (e.g., link adaptation) in the C-RAN 100; changing or adding hierarchical triggers; gathering additional, different, and/or more frequent metrics relating to the performance of the C-RAN 100; notifying an operator of a performance issue (e.g., relating to network elements or components) that requires further investigation; power cycling one or more devices; etc.

Optionally, a PRANmon component 107 can learn policies and triggers from the operation of a different C-RAN 100 deployment. For example, the decisions made by the PRANmon component 107 can be sent to cloud storage system, which can use the decision points from many deployments (e.g., utilizing maximum likelihood techniques) to create policies that apply to many different situations across many different deployments. This can be done using machine learning systems and methods.

Therefore, the PRANmon component 107 may be a centralized component that is capable of: (1) multiple-layer monitoring with audit capabilities; (2) dynamically adjusting logging and tracing functions at different granularities; (3) controlling system parameters; and/or (4) assisting existing functions by setting boundaries/thresholds/parameter sets for them.

Furthermore, the functionality of a PRANmon component 107 could be implemented in any type of distributed RAN (e.g., distributed antenna system (DAS)), not only a C-RAN 100.

### Example 5G C-RAN

FIG. 1B is a block diagram illustrating another exemplary configuration of a system 100B implementing data analysis and/or configuration of a C-RAN 100B. The system 100B includes 3GPP Fifth Generation (5G) elements. Optionally, the system 100B may additionally include 4G elements. Each of the elements may be implemented using at least one processor executing instructions stored in at least one memory. In some configurations, at least some of the elements are implemented using a virtual machine.

Fifth Generation (5G) standards support a wide variety of applications, bandwidth, and latencies while supporting various implementation options. In the system 100, interfaces denoted with “-c” or simply “c” (illustrated with dashed lines) provide control plane connectivity, while interfaces denoted with “-u” or simply “u” (illustrated with solid lines) provide user plane connectivity.

FIG. 1B illustrates a C-RAN 100B implementing an example of a 5G Next Generation NodeB (gNB). The architecture of a Next Generation NodeB (gNB) is partitioned into a 5G Central Unit (CU) 103, one or more 5G Distributed Unit (DU) 105 and one or more 5G Remote Units (RU) 106. A 5G Central Unit (CU) 103 is a node that implements the gNB controller functions such as the transfer of user data, mobility control, radio access network sharing, positioning, session management, etc. The 5G CU 103 controls the operation of the Distributed Units (DUs) 105 over an interface (including Fl-c and Fl-u for the control plane and user plane, respectively).

The Distributed Units (DUs) 105 may be nodes that implement a subset of the gNB functions, depending on the functional split (between CU 103 and DU 105). In some configurations, the L3 processing (of the 5G air interface) may be implemented in the CU 103 and the L2 processing (of the 5G air interface) may be implemented in the DU 105. The operation of each DU 105 is controlled by a CU 103. The functions of the DU 105 may include Radio Link Control (RLC), portions of Medium Access Control (MAC) and/or portions of the physical (PHY) layer functions. A Distributed Unit (DU) 105 can optionally offload some of its PHY (L1) processing (of the 5G air interface) to RUs 106.

In FIG. 1B, the C-RAN 100B includes a single CU 103, which handles control plane functions and user plane functions. The 5G CU 103 (in the C-RAN 100B) may communicate with at least one wireless service provider's Next Generation Cores (NGC) 112 using 5G NGc and 5G NGu interfaces. In some 5G configurations (not shown), a 5G CU is split between a CU-C 103B that handles control plane functions and a CU-U 103C that handles user plane functions.

In some 5G configurations, the RUs (RUs) 106 may communicate baseband signal data to the DUs 105 on an NG-iq interface. In some 5G configurations, the RUs 106 may implement at least some of the L1 and/or L2 processing. In some configurations, the RUs 106 may have multiple ETHERNET ports and can communicate with multiple switches.

Any of the interfaces in FIG. 1B may be implemented using a switched ETHERNET (or fiber) network. Additionally, if multiple CUs 103 are present (not shown), they may communicate with each other using any suitable interface, e.g., an Xn (Xn-c and Xn-u) and/or X2 interface. A fronthaul interface may facilitate any of the NG-iq, Fl-c, and/or Fl-u interfaces in FIG. 1B.

Where functionality of a baseband controller 104 is discussed herein, it is equally applicable to a 5G CU 103 or 5G DU 105 in 5G configurations. Therefore, where a C-RAN 100 is described herein, it may include 4G elements (as in FIG. 1A) and/or 5G elements (as in FIG. 1B).

In some configurations, the 5G CU 103, DUs 105, and/or RU(s) 106 may include a PRANmon component 107 that implements any of the functionality described herein, e.g., implemented as a set of instructions stored in a memory and executed by at least one processor in the respective device. Compared with a 4G configuration (e.g., FIG. 1A), a 5G configuration (e.g., FIG. 1B) includes a DU 105 with L1 and L2 user plane and control plane, which creates more interfaces and failure points within the C-RAN 100B. The PRANmon component 107 is particularly useful for 5G configurations because it gathers diagnostic information across different layers, elements, and components to provide real-time (or near real-time) diagnosis and policy-based action to address system performance issues.

Distributed Antenna System

A distributed antenna system (DAS) is another type of distributed RAN that includes at least two RUs 106 and a centralized distribution unit. The RUs 106 can wirelessly transmit signals to UEs 110 in a coverage area. The distribution unit can communicate channelized digital baseband signals with the RUs 106. The channelized digital baseband signals may include call information for wireless communication. The DAS may implement additional devices and/or functionality. A DAS may implement any suitable air interface, e.g., Third Generation Partnership Project (3GPP) 3G, 4G, and/or 5G air interface(s). In some configurations, a distribution unit and/or RUs 106 in a DAS may each implement a PRANmon component 107 as described herein.

Comparison with Other Solutions

Conventional solutions (for managing system performance in a C-RAN 100) try to do performance optimization in different ways. This includes, without limitation, log-analysis tools (from various vendors), UE tracing (from 3GPP), self-organizing network (SON) functions (from 3GPP with optional vendor-specific enhancements), link-adaptation functions (various vendor-specific mechanism), and RAN intelligent controllers (RICs). However, the systems and methods described herein are still useful, even with these existing tools and may even help these existing tools function better. Below is a description of existing tools and how the present systems and methods plays a distinct, independent, and co-operative role in coexistence with such other tools.

Log analysis tools mainly concentrate on offline, deep-dive log analysis and try to project graphs/reports to help debug certain scenarios. However, they don't influence the operations directly, other than to possibly alert the system management of possible problems. In contrast, a PRANmon component 107 operates in real-time (or near real-time) and can take quick actions based on symptoms and act on policies. As used herein, the term real-time (or near-real time) in the context of an action (e.g., diagnostic, evasive, corrective, etc.) means that the action is performed local to the RAN 100 (not in an external cloud system or the core network 112). In some configurations, a real-time (or near-real-time) action is performed quickly enough such that the problem can be addressed without taking the relevant components or elements offline and without the problem getting substantially worse with respect to providing wireless service (e.g., keeping KPIs above minimum thresholds), accepting calls, passing traffic (e.g., meeting minimum quality of service).

For example, one of the main actions available to a PRANmon component 107 is to detect failure conditions and increase the frequency at which logs are measured at different components, thus triggering tracing of protocol messaging dynamically. The PRANmon component 107 may also stop (or reduce the frequency of) tracing to baseline levels automatically, e.g., when a KPI returns above a threshold or when the KPI does not return above the threshold after a period of time. These PRANmon component 107 roles are independent and can further help the log-analysis tools to improve the analysis of the overall performance of the system. Apart from this, the PRANmon component 107 can also trigger further policy actions to mitigate the effect of failure conditions.

UE-tracing is another 3GPP-specific method that captures every UE-specific activity on RAN devices (e.g., in an Extensible Markup Language (XML) file sent to the cloud servers (e.g., MME)) for analysis. UE-tracing can assist in understanding issues and/or failures that cause KPI degradation. However, UE tracing is also an offline processing method and does not have the control capabilities of the PRANmon component 107, especially in real-time (or near real-time).

Self-organizing network (SON) functions are also widely defined in 3GPP documents, on top of which there can be various vendor-specific variations. SON functions may perform parameter-based network optimization to influence the behavior of the RAN devices, e.g., automatic physical cell identifier (PCI) configuration, automatic root sequence index (RSI) configuration, mobility-robustness optimizations, hand-off optimizations, Minimization of Drive Test (MDT), etc. While SON focuses on gathering parameters from local KPIs, peer entities (neighboring eNBs), and UE reports, a PRANmon component 107 may gather parameters at different layers and/or components within the RAN devices for specific UE-level and/or RU-level diagnosis. Unlike SON, the PRANmon component 107 also aids in activating or de-activating features at specific UE-level and/or RU-level, thus controlling log levels (frequency) automatically for specific UEs/RNTIs to help gather information for offline debugging. Since the PRANmon component 107 acts as an over-arching control component with complete visibility into different layers/components, it can also help guide SON functions to operate better. For example, SON typically uses an Automatic Neighbor Relation (ANR) function in UEs 110 to trigger measurements periodically to learn about neighbor environments and decide on eNB system parameters. But the ANR function doesn't know the radio conditions of the UEs 110, load on the UEs 110, etc. This may cause the ANR to pick up a wrong UE 110 causing performance degradations and may even result in a UE 110 getting dropped from the system (while not completing the ANR function as well). In such situations, the PRANmon component 107 can help to pick the right set of UEs 110, based on its own policies, as it has visibility across different layers.

Link-adaptation functions and implementations also seek to manage performance aspects of RAN systems. However, link-adaptation is typically associated with Layer-2 of the air interface in order to: fine-tune the resource-block allocation, code-rate selection, and power-control decisions; and improve the MAC-layer throughput between the RAN and the UEs 110. The PRANmon component 107 is more akin to an outermost loop that guides the link-adaptation functions in an advantageous way. For example, a PRANmon component 107 can dynamically adjust RLC retransmission parameters, physical downlink control channel (PDCCH) aggregation level settings and/or downlink control (DCI) format usage at a per-UE level based on its adaptable self-monitoring capabilities. In contrast, these parameters are not controlled by the link-adaptation function. Basically, a PRANmon component 107 can learn from different inputs across multiple layers and apply policy options in order to adjust the link-adaptation settings in a more dynamic way.

A RAN intelligent controller (RIC) has 2 separate components: a non-real-time RAN intelligent controller (nRT-RIC) in the cloud; and near real-time RAN intelligent controller (RTRIC) closer to the RAN. More details of the RIC are available at https://wiki.o-ran-sc.org/pages/viewpage.action?pageId=10715420&preview=/10715420/10715422/Near_RT_RIC_for_ONS. More specifically the near-RT-RIC (shortened to RTRIC here), is composed of xApps (mobility optimization, RRC optimization, KPI monitoring, admission-control apps, etc.). The RIC uses the E2 messaging interface to talk to the CU 103 and/or DU 103. The RIC implements the generic concepts of event trigger, action, and control sequences, and it is mainly catered to the policy-driven implementation of those RAN functions (like RRC management, mobility management, etc.). In contrast, the PRANmon component 107 performs a series of hierarchical audit/diagnosis functions and collects the right amount of debug-information for the violation conditions at different levels. To that extent, the RIC can be useful for policy-driven components, whereas a PRANmon component 107 helps in diagnosing/debugging the very same components, when intended policies are not working.

Inputs and Outputs

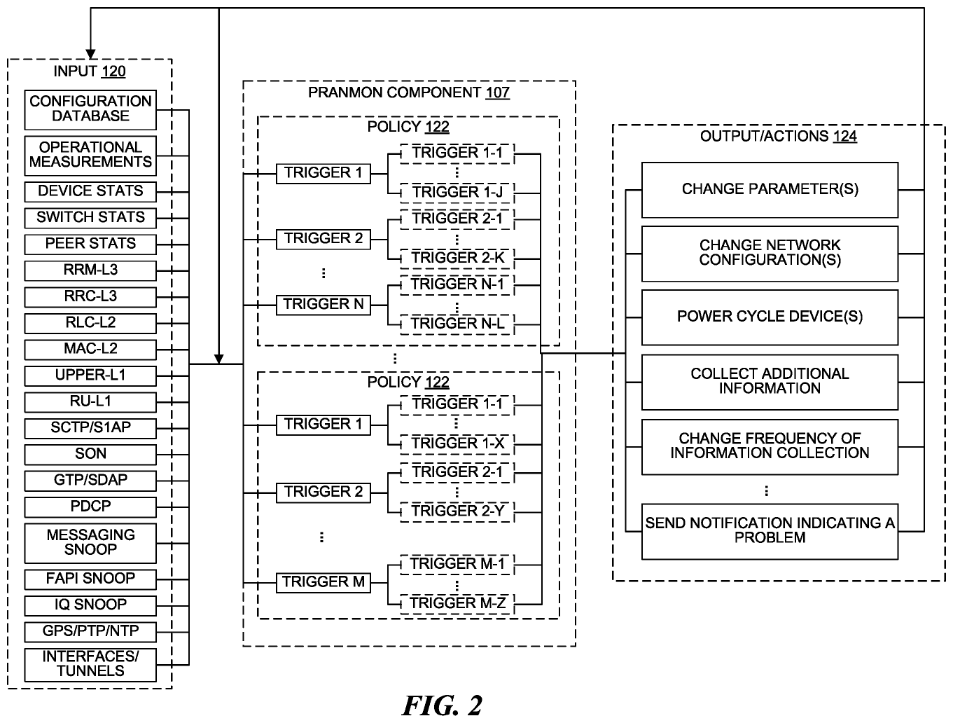

FIG. 2 is a block diagram illustrating example inputs 120 and outputs 124 to a PRANmon component 107 in a distributed radio access network (RAN). Specifically, FIG. 2 illustrates the PRANmon component 107 as a central entity managing the performance of different components in the system, as well as external entities. For example, the PRANmon component 107 may include at least one policy 122 with various triggers. The triggers operate based on input 120 from various components and devices in the RAN.

The PRANmon component 107 may receive input 120 from a variety of different components and devices. Without limitation, the input 120 may include: a configuration database indicating various configurations in the RAN (e.g., frequency band used by the RAN, bandwidth of the frequency band, public land mobile network (PLMN) ID, number of users served or sectors implemented by the RAN, current combining groups, aggregation levels of particular channel(s), frequency reuse configuration in use, etc.); operational measurements (e.g., throughput, cyclic redundancy check (CRC) failures, block error rate (BLER), connection drop rates, handover rates, other KPIs, etc.) for either the whole eNB, at least one UE 110 and/or at least one RU 106; device statistics (e.g., packet count to or from different interfaces, dropped packet counts, errored packet counts on specific channels); switch stats (e.g., count of packets processed or dropped in a particular fronthaul network 116 switch interface); and/or peer eNodeB statistics (standard information like Inter-Cell Interference Coordination (ICIC) information, load-information (RAN Information Management (RIM)), and proprietary information like handover failures or success, proprietary load-information at the RU 106 level). Furthermore, the input 120 may include various layer-specific metrics, described in the 3GPP Technical Specifications (specifically 3GPP TS 32.450 and 32.451) such as: metrics for radio resource control and radio-resource management, self-organizing network function (RRC and RRM and SON, which are L3 functions); metrics for radio link control and MAC control (RLC and MAC which are L2 function); metrics for L1 (e.g., performed at the baseband controller 104, 5G CU 103, or DU 105 and RU-portions). Furthermore the input 120 may include layer-specific proprietary metrics for the control-plane protocols like Stream Control Transmission Protocol (SCTP), S1 Application Protocol (S1AP) processing, Internet Key Exchange (IKE) protocol; metrics for data-plane protocols like GPRS Tunneling Protocol (GTP), Selective Data Adaptive Protocol (SDAP) for 5G; and/or metrics for Packet Data Convergence Protocol (PDCP) and/or IP security (IPSec); metrics for the timing systems like Global Positioning System (GPS), Precision Time Protocol (PTP), or Network Time Protocol (NTP). Additionally, the input 120 may include various inter-component and/or inter-device messages gathered in the RAN, such as: femto application platform interface (FAPI) messages; in-phase, quadrature-phase (IQ) messages; and/or other type of inter-component messages.

Performance metrics (such as the input 120) are metrics obtained at a particular layer of the relevant air interface, e.g., MAC metrics, RLC metrics, RRC metrics, RRM metrics, etc. In some cases it is most useful to collect these metrics with additional qualifying/contextual metrics that further explain the metrics' behavior. In other words, the qualifying metrics qualify the original performance metric. In order to identify qualifying metrics (in addition to the original performance metrics), each policy 122 may include a set of hierarchical triggers.

For example, various input 120 may be fed to one or more first-level triggers, where each first-level trigger is a comparison of at least one input 120 to a particular threshold. Based on the results of the first-level trigger(s) (e.g., which first-level trigger(s) were TRUE), one or more second-level triggers may be used. For example, only second-level trigger(s), which are sub-triggers to the first-level triggers that were TRUE, are used in some configurations. Based on the results of the second-level trigger(s) (e.g., which second-level trigger(s) were TRUE), one or more third-level triggers (not shown in FIG. 2) may be used, and so on.

As an example, if uplink BLER for one or more UEs 110 exceeds a BLER threshold (in a first-level trigger), it could be an issue in either the PUCCH or PUSCH. For Downlink BLER, it could be a HARQ ACK (success), a HARQ NACK (failure), or a DTX (discontinuous transmission) issue (e.g., the UE 110 is not aware of this transmission to report either ACK or NACK). Therefore, these issues (PUCCH or PUSCH for uplink, or ACK, NACK, or DTX for downlink) may be checked by second-level triggers. Then, if the uplink BLER is a PUCCH problem, then further actions 124 could be additional third-level trigger(s) to determine whether it is a fronthaul 116 issue or any other issue. So an action 124 could be check fronthaul counters (which forms a new input 120 to a fourth-level trigger to gather them) and, if there are drops, an action 124 to investigate them. In this way, one action 124 could trigger a whole new input 120 for another trigger, e.g., in a recursive loop.

In some examples, each trigger is a comparison of a particular input 120 (or inputs 120) with a threshold (or thresholds). Without limitation, examples of triggers include: comparing the number of cyclic redundancy check (CRC) failures on transmissions to and/or from a particular UE 110 (or set of UEs 110) to a CRC threshold; comparing the BLER on transmissions to and/or from a particular UE 110 (or set of UEs 110) to a BLER threshold. Each trigger may be associated with zero, one, or more than one action 124. For example, if the CRC failures for a UE 110 (or set of UEs 110) during a window exceeds the CRC threshold, the trigger may be deemed TRUE and a corresponding action 124 may be taken. Similarly, if the BLER during a window exceeds the BLER threshold, the trigger may be deemed TRUE and a different corresponding action 124 may be taken. Additionally, the same action 124 may be associated with more than one trigger.

The triggers at any level within the hierarchy of triggers (in the policy 122) may have at least one action associated with it (not just the last level of trigger that is used). Furthermore, some triggers may have at least one corresponding action (if the trigger is TRUE) and also generate new inputs 120, which in turn activate further trigger(s) and action(s) 124. For example, if a first-level trigger determines that CRC errors for downlink transmissions from a particular RU 106 exceed a CRC threshold, the RU 106 may be removed from one or more combining groups (an action 124) and further triggers may be activated, e.g., to collect and analyze other diagnostic information for the RU 106. Accordingly the hierarchical trigger(s) may determine at least one action following processing of the diagnostic information.

In some examples, at least one action 124 may be associated with a particular trigger. Without limitation, examples of actions 124 include: changing parameters (e.g., in RU(s) 106, DU(s) 105, 5G CU(s) 103, a baseband controller 104, UE(s) 110, etc.); changing network configuration(s) (e.g., changing combining group(s), deactivating one or more RU(s) 106, etc.); collecting additional information (that wasn't previously being collected); changing the frequency that information is being collected; and/or sending a notification (e.g., to the operator of the C-RAN 100 via a management system) indicating a problem that needs further action or analysis.

In this way, the hierarchical triggers in the policy 122 act as a decision tree to classify system performance issues with a C-RAN 100 (or other distributed RAN, such as a distributed antenna system (DAS)) and act (e.g., diagnostic, evasive, corrective, etc.) to address it.

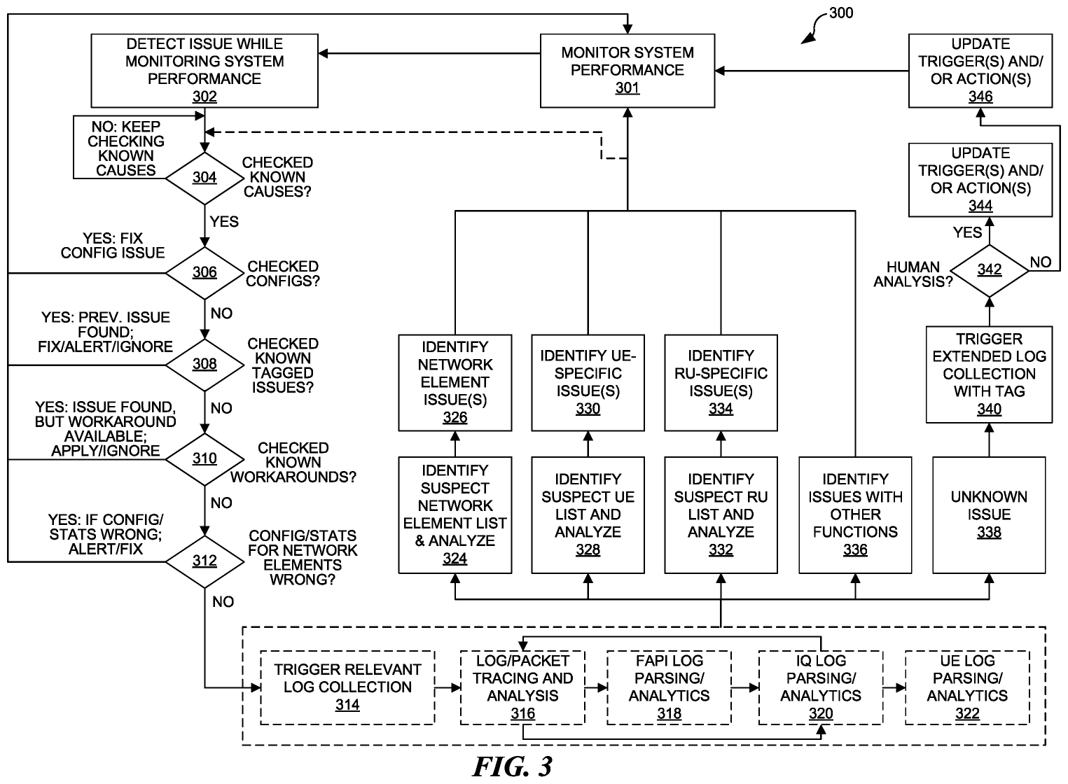

FIG. 3 is a flow diagram illustrating an example method 300 for data analysis and configuring a cloud radio access network (C-RAN) 100. The method 300 may be implemented by at least one processor (e.g., implementing at least one PRANmon component 107) in at least one RU 106, and/or at least one baseband controller 104, 5G DU 105, or 5G CU 103.

The method 300 in FIG. 3 will monitor system performance issue and, if a symptom is detected, attempt to determine the cause. Using the method 300, a PRANmon component 107 may detect a KPI-affecting condition, dynamically trigger tracing/logging level adjustments, aid in further analysis of the issue, etc.

In response to a system performance issue being detected (in step 302), the method 300 generally proceeds with checks of various existing data (steps 304-312 on the left side of FIG. 3), followed by log collection of additional data (steps 314-322 on the bottom of FIG. 3), followed by problem classification (steps 324-336) and/or additional log collection for issues still not identified (in steps 338-346). In examples, the method 300 may be iteratively performed, e.g., periodically, continuously, in response to user input, etc.

The blocks of the flow diagram shown in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel and/or in an event-driven manner). Also, most standard exception handling is not described for ease of explanation; however, it is to be understood that method 300 can and typically would include such exception handling.

The method 300 begins at step 301 where at least one processor (in at least one UE 110, at least one RU 106, and/or at least one baseband controller 104, 5G DU 105, 5G CU 103, or distribution unit of a DAS) monitors system performance in the C-RAN 100. This may include using at least one trigger to compare at least one input 120 to at least one threshold (or monitor one input 120, which can be an alarm/event (like a port is down, etc.)). For example, step 301 may include comparing the number of CRC failures for at least one UE 110 to a CRC threshold; comparing the BLER for at least one UE 110 to a BLER threshold; comparing a call processing metric (e.g., for at least one UE 110) to a success threshold, etc. These comparisons may occur periodically as new input 120 metrics are determined, on-demand (e.g., in response to user input), and/or in response to an action being taken to correct a previously-addressed issue with system performance.

The method 300 proceeds at step 302 where an issue is detected while monitoring system performance. For example, one of the triggers may be TRUE following a comparison of input 120 to a threshold, e.g., CRC failures for at least one UE 110 exceed the CRC threshold, the BLER for at least one UE exceed the BLER threshold, throughput for at least one UE 110 falls below a throughput threshold, etc.

The method 300 proceeds at step 304 where known causes (for the detected issue) are checked. The known causes may be learned over time by the C-RAN 100 and/or other C-RAN 100 deployments. In some examples, the learned causes may be stored in a memory that is accessible to the elements in the multiple C-RAN 100 deployments. In some examples, step 304 may include multi-dimensional (e.g., multi-input) pattern-matching to identify similar scenarios that were previously encountered and, if a similar scenario is identified, determining the cause identified in the similar scenario is the same cause of the presently-detected issue (in step 302).

However, sometimes a known cause for an issue has not previously been identified. In such cases, the method 300 proceeds at step 306 where at least one configuration is checked. This could include checking a network and/or parameter configuration, e.g., of a particular device, component, etc. If there is a configuration problem identified, it is fixed and the system performance continues to be monitored. For example, if the issue is related to mismatched configurations in different C-RAN 100 components or devices, one or both configurations may be changed.

As an example of step 306, suppose that LTE band 29 was configured for a neighbor eNB, which causes an eNB to ask UEs 110 to do measurements and trigger handovers. But this band 29 is downlink-only spectrum and the UEs 110 will not be able to attach to that system (this is typically for 2nd carrier for DL-only carrier aggregation). So after noticing repeated handover failures, the configuration of neighbor bands could be checked in step 306 and this band 29 configuration would be removed.

If no configuration problems are identified, the method 300 proceeds to step 308 where known tagged issues are checked. If a known tagged issue is identified, it may be fixed, a notification may be sent (e.g., to a management system), or ignored, after which system performance continues to be monitored. For example, if the current issue matches a known tagged issue, part or all of the issue to be ignored (e.g., because there are no known fixes, the fix is scheduled at the next maintenance, the issue is transient, etc.). For example, if a transient issue is known and expected, it may be ignored because it is expected to resolve itself shortly.

As an example of step 308, assume that a neighboring macro base station had a wrong configuration, which caused it to direct UEs 110 to the un-intended eNB (e.g., C-RAN 100) instead of an intended eNB (e.g., C-RAN 100). When the neighboring macro base station is handing the UEs 110 (that are not even capable of operating on band 66) to the un-intended eNB (e.g., C-RAN 100, which is operating in band 66), the un-intended eNB (e.g., C-RAN 100) would reject these handovers. This leads to KPI degradation. Even though the logs could be provided to the macro base station's operator(s), it would take multiple days to correct the misconfiguration. Meanwhile this sort of failure can be tagged as a “known issue” and, while looking at the overall hand-in KPIs, these can be ignored.

If no known tagged issues are identified, the method 300 proceeds to step 310 where known workarounds are checked. If a known workaround is found and available, it may be applied (with or without a corresponding alert to a management system) or ignored, after which system performance continues to be monitored.

As an example of step 310, in a system of multiple eNBs (e.g., C-RANs 100), service will be affected when one of the eNBs is not able to synchronize with the timing source. As the other systems in the same site are operating, the quick workaround would be to isolate the affected eNB's timing component and reset the specific part, then perform recovery.

If no known workarounds are identified, the method 300 proceeds to step 312 where the configurations and/or stats for network elements are checked to identify a solution to the issue. If a problem in the configurations and/or stats for network elements is found, it may be applied or ignored, after which system performance continues to be monitored.

As an example of step 312, if the uplink CRC errors are creeping up, it could be an issue with the fronthaul 116 links. If so, the front-haul switches per-port packet statistics could be gathered in step 312 and checked for any dropped and/or discarded packets. If there are drops and/or discards, the root cause affecting the interface may be identified and, if necessary, the quality of service (QoS) configuration on the switch may be corrected.

Additionally if steps 304-312 don't yield any specific solutions, the method 300 proceed to trigger further data collection/real-time log capture and analysis to detect any interface-related issues in steps in steps 314-322. From the logs and traces, depending on the type of the issue, appropriate lists of network-elements, UEs 110, and/or RUs 106 may be prepared. Similarly, a list of other functions may be prepared for further analysis.

Specifically, the log collection in step 314 may trigger log parsing and packet tracing (in the S1 interface, IPSec interface, or L2/L3 interface), as well as analysis in step 316, femto application platform interface (FAPI) log parsing and analysis in step 318, in-phase, quadrature-phase (IQ) log parsing and analysis in step 320, and/or UE 110 log parsing and analysis in step 322. Log parsing may include manipulating the collected data into a more-usable form. Log analysis may include interpretation of the data to identify issues in the system.

Following log collection and analysis (in any of steps 314-322), the method 300 proceeds to problem classification. This can include a decision-based classification based on the log data. For example, the method 300 proceeds to step 324, 328, 332, or 336, depending on analysis of at least one log of diagnostic information.

In step 324, a list of network element(s) (e.g., switch(es) in a fronthaul network 116) is identified as potentially problematic based on the collected log information. Following step 324 (if performed), at least one network element (e.g., switch) is identified from the list of potentially-problematic network element(s) in step 326. At that point, the system performance would continue to be monitored (and, optionally, steps taken to fix, restart, replace, re-configure, and/or remove the offending network element(s)).

In step 328, a list of UE(s) 110 is identified as potentially problematic based on the collected log information. Following step 328 (if performed), at least one UE 110 is identified from the list of potentially-problematic UE(s) 110 in step 330. At that point, the system performance would continue to be monitored (and, optionally, steps taken to re-configure and/or drop the offending UE(s) 110).

In step 332, a list of RU(s) 106 is identified as potentially problematic based on the collected log information. Following step 332 (if performed), at least one RU 106 is identified from the list of potentially-problematic RU(s) 106 in step 334. At that point, the system performance would continue to be monitored (and, optionally, steps taken to fix, restart, replace, re-configure, and/or remove the offending RU(s) 106).

In some configurations, the method 300 returns to step 304 (path shown in a dotted line) following the identification of a network-element-specific issue (step 326), a UE-specific issue (step 330), and/or an RU-specific issue (step 334). For example, steps 326, 330, and/or 334 may take action 124 and/or gain new information after which it would be beneficial to perform steps 304, 306, 308, etc.

If no potentially-problematic network element(s), UE(s) 110, or RU(s) are identified in steps 324, 328, and 332, respectively, issues with other RAN processes may be identified in step 336. For example, problem(s) may be identified with existing UE-tracing, a SON, and/or link adaptation implementations. If this type of problem is identified, (1) the process may be fixed by changing or improving the configuration; (2) the process may be optimized by providing additional information to the process; (3) steps taken to disable the process; and/or (4) a notification can be sent that indicates the problem (e.g., to a management system).

Despite the previous steps, there may be some situations where there's no known resolution to the current system performance issue. Accordingly, when potentially-problematic network element(s), UE(s) 110, or RU(s) 106 are not identified in steps 324, 328, and 332 and no problem is identified with other processes in step 336, an unknown (e.g., previously-unidentified) issue is declared in step 338. At that point, extended log collection may be performed in step 340, e.g., beyond the type of data and/or frequency of collection currently being collected. This log data may be tagged with an identifier that indicates it is related to the unknown issue/problem. In this way, the different log data for a particular problem can be easily identified for analysis.

Following (or during) this extended log collection, it is determined whether human analysis of the extended log data is required in step 342. If it is, relevant rule(s), filters, triggers, tags, and/or actions are updated (e.g., in databases) in step 344, so that future analysis can benefit from this information. Step 344 can include updating triggers, and/or actions 124 in the eNBs (e.g., in the PRANmon components 107). Following step 344, system performance is monitored. Optionally, a notification is sent (e.g., to a management system) indicating that extended log collection data is available relating an unknown problem is available for analysis. When even human analysis doesn't give specific leads as to the root cause, then the policies 122, specific triggers, and/or actions 124 may need to be updated again to collect more data.

However, even if human analysis is not successful in identifying a root cause, relevant rule(s), filters, triggers, tags, and/or actions are updated may be updated or added in step 346 and system performance is monitored. In some configurations, the steps (being updated or added) may be hierarchical triggers used to determine actions based on input 120.

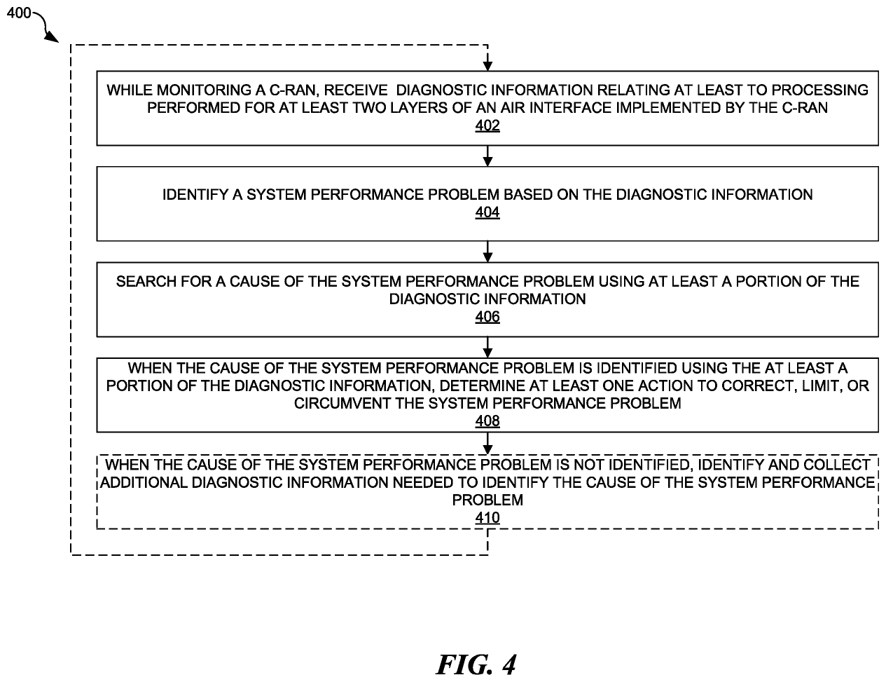

FIG. 4 is a flow diagram illustrating a method 400 for data analysis and configuration of a distributed RAN (e.g., C-RAN 100 or DAS). The method 400 may be implemented by at least one processor (e.g., implementing at least one PRANmon component 107) in at least one RU 106, and/or at least one central unit (e.g., baseband controller 104, 5G DU 105, 5G CU 103, or distribution unit in a DAS). In some configurations, the method 400 is performed by at least one processor in a central unit in a distributed RAN.

Additionally, the blocks of the flow diagram shown in FIG. 4 have been arranged in a generally sequential manner for ease of explanation; however, it is to be understood that this arrangement is merely exemplary, and it should be recognized that the processing associated with method 400 (and the blocks shown in FIG. 4) can occur in a different order (for example, where at least some of the processing associated with the blocks is performed in parallel and/or in an event-driven manner). Also, most standard exception handling is not described for ease of explanation; however, it is to be understood that method 400 can and typically would include such exception handling.

The method 400 begins at step 402 where, while monitoring a distributed RAN, diagnostic information is received, which relates at least to processing performed for at least two layers of an air interface (e.g., 3G, LTE, 5G, etc.) of the distributed RAN. For example, at least some of the diagnostic information may relate to the state of various protocol processing in the distributed RAN, e.g., MAC, RLC, RRC, RRM, CU-L1, RU-L1, etc. For example, the diagnostic information may be performance metrics relating to the performance (e.g., efficiency, throughput, data errors, etc.) of the processing for any function within L1, L2, and/or L3 of the air interface. The diagnostic information may also relate to different DL channels (e.g., PDCCH, PDSCH, etc.) and/or UL channels (e.g., PUSCH, RACH, SRS, PUCCH, etc.). The diagnostic information may also relate to network interfaces or other internal interfaces in the distributed RAN.

Put another way, the diagnostic information may relate to any part of the RAN interface, which includes, but is not limited to, the air interface (e.g., 4G, 5G, etc.), interfaces of the backhaul network 114 (e.g., LTE-S1C/S1U interface, IKE/IPSec tunnels, IPv4/IPv6 transport interfaces), interfaces of the fronthaul network 116, timing-interface (e.g., PTP between any of the RAN devices, such as a baseband controller 104, RU(s) 106, 5G CU 103, DU 105, or between the RAN devices and a grandmaster clock (not shown)). The diagnostic information may also relate to various resource usage or capacity within any RAN device, e.g., resources such as CPU, memory, and/or other storage. In some examples, the diagnostic information may include debugging logs or other logs relating to communication between a baseband controller 104 or 5G CU 105 and RUs 106.

Without limitation, any of the input 120 described in FIG. 2 may be included in the diagnostic information. The diagnostic information may be collected in at least one UE 110, at least one RU 106, at least one switch (in a fronthaul network 116), at least one baseband controller 104, at least one 5G DU 105, at least one 5G CU 103, and/or at least one distribution unit (or a DAS). In some configurations, the diagnostic information may be collected at more than one device (multiple different RUs 106) and/or more than one type of device (UE(s) 110 and RU(s) 106). In some configurations, the diagnostic information may be collected at a first device or component (or set of devices or components) and transmitted to a second device for analysis, e.g., RU(s) 106 may collect the diagnostic information and send to a centralized device, such as a baseband controller 104, a 5G DU 105, a 5G CU 103, or a distribution unit. Although specific examples are given herein, the term “diagnostic information” may refer to any metric or other indication of system performance in a distributed RAN. In some configurations, the diagnostic information includes key performance indicators (KPIs).

In some examples, KPI(s), metric(s), and/or alarm(s) are the top-level symptoms. The KPI(s), metric(s), and/or alarm(s) may be periodically measured, monitored, or derived before being analyzed. In some cases, these KPI(s), metric(s), alarm(s), and/or other event are compared to a threshold to identify any impending events or problems in the distributed RAN. Some of them could be defined at 3GPP, while others are vendor-specific. By identifying the trends in them, the next level of analysis could look at other diagnostic information, e.g., command line interface (CLI) counters, packet-traces, other diagnostic logs, etc.

The method 400 proceeds at step 404 where a system performance problem is identified based on the diagnostic information (e.g., input 120), e.g., using at least one policy 122 (with triggers). For example, CRC errors for a UE 110 (or set of UEs 110) in the distributed RAN may exceed a CRC threshold and/or BLER errors for a UE 110 (or set of UEs 110) in the distributed RAN may exceed a BLER threshold. In some configurations, step 404 may include using a first-level trigger to compare some of the diagnostic information to a relevant threshold.

The method 400 proceeds to step 406 where a known cause of the system performance problem is searched for using at least a portion of the diagnostic information (e.g., input 120), e.g., using at least one trigger in the at least policy 122. The cause of a system performance problem can include one or more components, devices, types of devices, and/or functions that are causing the system performance problem. For example, a central unit (e.g., a baseband controller 104, a 5G DU 105, or a 5G CU 103) may search a database of previously-encountered system performance problems (either in the distributed RAN or a different distributed RAN deployment). Step 406 may include the central entity trying to match a pattern of different diagnostic information, which is expected to be relevant to the current system performance problem, to a pattern of diagnostic information collected during a previous performance problem. In some configurations, there are multiple sources for a particular policy 122, e.g., polic(ies) learned in one eNodeB (e.g., C-RAN 100) may be used at a different eNodeB (e.g., C-RAN 100). Similarly, a particular trigger may be used in different policies 122, e.g., more than one policy 122 may compare a particular KPI or another metric to a relevant threshold.

The method 400 proceeds to step 408 where, when the known cause of the system performance problem is identified (in step 406), at least one action 124 is determined to correct, limit, and/or circumvent the system performance problem. Without limitation, the at least one action may include changing parameter(s) of various components or devices (e.g., in RU(s) 106, DU(s) 105, 5G CU(s) 103, a baseband controller 104, UE(s) 110, distribution unit, etc.); changing network configuration(s) (e.g., changing combining group(s), deactivating one or more RU(s) 106, etc.); and/or sending a notification (e.g., to the operator of the distributed RAN via a management system) indicating a problem that needs further action or analysis.

The method 400 proceeds to optional step 410 where, when the known cause of the system performance problem is not identified (in step 406), additional diagnostic information (needed to identify the cause of the system performance problem) is identified and collected. Without limitation, optional step 410 may include collecting additional information (that wasn't previously being collected); and/or changing the frequency that information is being collected.

Any of steps 404-410 may include using at least one trigger in at least one policy 122 stored on at least one device in the distributed RAN. In examples, the triggers in each policy 122 may be hierarchical. As described above, the second-level triggers used (if any) may depend on the results of the first-level trigger(s) (e.g., which first-level trigger(s) were TRUE). Similarly, the third-level triggers used (if any) may depend on the results of the second-level trigger(s) (e.g., which second-level trigger(s) were TRUE).

In some configurations, each output/action 124 can optionally create new inputs 120, which can be used by a further set of policies 122 with their own set of triggers and outputs/actions 124—in a recursive manner. For example, if high CRC failures are identified, a first policy 122 might be used to check if the problem is limited to a particular RU 106 (or RUs 106), a second policy 122 might be used to check if the problem is in the baseband controller 104 or 5G CU 103, and a third policy 122 might be used to check if the problem is in a particular UE 110 (or UEs 110). The first policy 122, second policy 122, and third policy 122 may each have their own respective input(s) 120, trigger(s), and action(s) 124 associated with it. Furthermore, a particular policy 122 can be a composite of multiple policies 122, e.g., the first policy 122 and third policy 122 can be used together before the second policy 122 is used.

As an example of the hierarchical operation, assume the block error rate (BLER) is showing a problem (e.g., is setting off a first-level trigger) in a distributed RAN, e.g., the system performance problem is identified in step 404. A cause of the high BLER may be searched for in step 406, e.g., searching a database to find a similar scenario. This can include using additional layers of triggers to determine whether the cause of the high BLER is an RU 106 problem, a baseband controller 104 problem, a DU 105 problem, a CU 103 problem, a network problem, link adaptation problem, etc. So, a first second-level trigger might check if it is an RU 106 problem by checking whether the RU 106 is functional, e.g., whether the RU 106 is sending the packets through the network properly, etc. If the RU 106 is not working, then action 124 can be determined in step 408, e.g., remove the problematic RU 106 from operation and/or from particular combining group(s) or reset (power cycle) the RU 106. If the RU 106 works, a third-level trigger may check if the baseband controller 104 (4G) or 5G CU 103 is working in which case the action 124 in step 408 may be to reset or re-configure offending device. If the baseband controller 104 (4G) or 5G CU 103 is working, a fourth-level trigger may check for link adaptation problem(s), in which case the action 124 in step 408 may be to adjust the power level of the UE 110, handoff the UE 110 to another eNB (e.g., C-RAN 100), etc. Therefore, the selected action(s) 124 in step 408 are different depending on the offending component or device because there are different possible actions in different components or entities. Alternatively, if the hierarchical triggers can't identify the particular entity or entities causing the high BLER, additional diagnostic information (needed to identify the cause of the high BLER) may be identified and collected during further monitoring.

Below are several examples of how the present systems and methods might be used to audit, diagnose, and/or resolve system performance issues in a distributed RAN (e.g., C-RAN 100 or DAS).

Example Scenarios

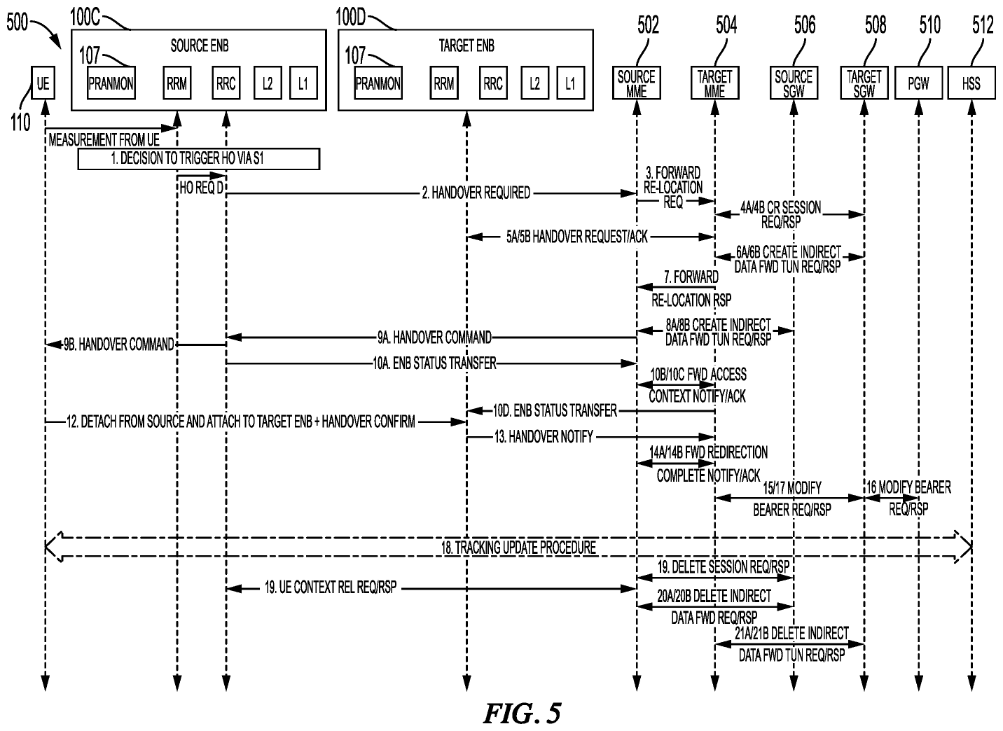

FIG. 5 is a sequence diagram 500 illustrating a scenario for debugging diagnostic information, e.g., key performance indicator(s). In this scenario, an eNB (e.g., a C-RAN 100C-D) with the PRANmon capabilities is acting as target eNB 100D and is being monitored continuously for hand-in performance of UEs 110 from a neighboring source eNB 100C. Several other devices are illustrated in FIG. 5: a source MME 502, a target MME 504, a source serving gateway (GW) 506, a target serving GW 508, a packet data network (PDN) GW 510, and a home subscriber server (HSS) 512. Instead of the scenario illustrated in FIG. 5, the sequence illustrated in FIG. 5 and described in Section 10.1.2.1.1 of 3GPP Technical Specification 36.300 (v15.8.0) could be used.

In a typical hand-in scenario (e.g., in an LTE or 5G network), the source eNB 100C requests that the UE 110 measure neighbors' signal strength and, based on the results, decides to handover the UE 110 to the target eNB 100D (e.g., C-RAN 100D). Initially, the source eNB 100C requests that the target eNB 100D (e.g., C-RAN 100D) allocate resources for the UE 110, e.g., dedicated preamble and other channel resources, such as scheduling request (SR), channel quality indicator (CQI), GTP tunnel ID, Radio Network Temporary Identifier (RNTI), etc. The target eNB 100D (e.g., C-RAN 100D) allocates these and sends them as a target-to-source container to be sent to the UE 110 over the air as an RRC re-configuration message. Now the UE 110 tries to do RACH procedures with the target eNB 100D using the dedicated RACH preamble and tries to send an RRC re-configuration complete message (indicating that the RAN-side handover procedure is complete). This is termed a successful hand-in and further S1/X2-messaging completes the procedure.

This sequence is illustrated in FIG. 5, through several messaging steps between network elements. FIG. 5 doesn't show the components involved in this scenario within each of network elements, such as the source eNB 100C or target eNB 100D.

In certain cases, however, there may be failure(s) in the eNB(s) and/or in other network elements involved in the hand-in process. There are various cause-codes exchanged for these failure cases. The following are possible points of failure in the handover/hand-in process.

The target eNB 100D may not be able to allocate correct resources and/or may follow certain admission control procedure resulting in hand-in failures. If it is admission control/overload situation, further hand-ins to that target eNB 100D may keep failing and so some pre-emptive action may be necessary to avoid further hand-in failures.

Likewise, the UE 110 may not be able to complete the RACH and/or RRC re-config procedure with the target eNB 100D, due to signal to interference plus noise ratio (SINR) conditions and/or SR detection issues. Additionally, the target eNB 100D may not be expecting hand-in, which may result in hand-in failure.

Sometimes if these types of failures occur, and UE 110 tries to do RRC-re-establishment at the target eNB 100D (e.g., C-RAN 100D). However, the target eNB 100D may not be able to accept this (e.g., if it has already released the UE 110 due to a timeout) and ends up forcing UE 110 to come in via a new RRC connection request. This would result in a hand-in failure.

Sometimes, the UE 110 moves further away from the target eNB 100D and ends up doing RRC re-establishment back on the source eNB 100C. In this case, the target eNB 100D never gets to see the UE 110 on its RAN, which would result in a hand-in failure.

As can be seen, there are several possible steps and layers where failures can happen during the hand-in process. The PRANmon component(s) 107 may have complete visibility within the entities and may collect the logs from messaging infrastructure like FAPI, L2-L3 Messaging, S1AP, Debug logs, and/or any other logs concurrently. Additionally, sometimes UE 110 side logs may also be collected (in case the source eNB 100C side logs are not available or accessible). For example, PRANmon component(s) 107 can be embedded in the source eNB 100C and/or target eNB 100D to watch the hand-in scenarios, counters, and take necessary policy actions depending on different failure cases. As described below, the PRANmon component(s) 107 can use this gathered diagnostic information to diagnose and act to prevent, correct, or mitigate these points of failure.

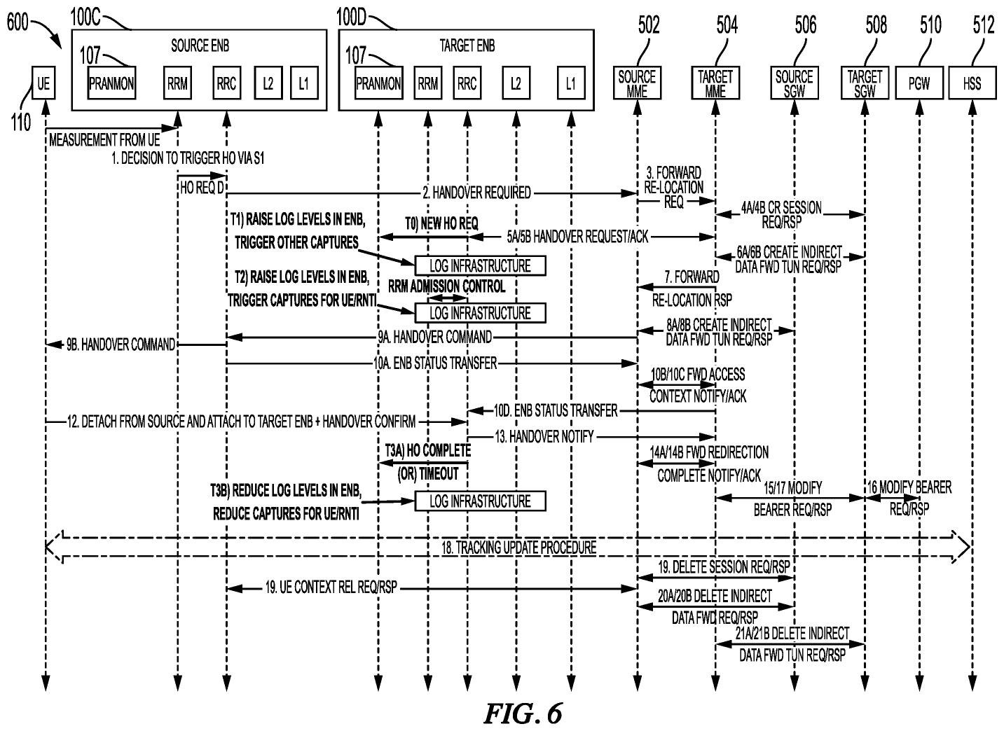

FIG. 6 is a sequence diagram 600 illustrating various points where additional action could be taken by a target eNB 100D to debug hand-in failures. FIG. 6 illustrates the same system as in FIG. 5, but with more component-level detail. Therefore, where a particular step includes the same number in FIGS. 5 and 6 (e.g., step 5: Handover Request from MME), it refers to the same step. In other words, FIG. 6 may illustrate only a subset of the steps from FIG. 5, although it is understood that FIG. 6 may include all the steps of FIG. 5 (with the addition of the “T” steps that are not in FIG. 5). The steps beginning with “T” (in bold type in FIG. 6) are steps involving the PRANmon component 107 in the target eNB 100D.

The PRANmon component 107 in the target eNB 100D can detect hand-in failures breaching a hand-in threshold from certain neighbor eNBs (e.g., the source eNB 100C). For example, the hand-in failures may be input 120 to a trigger (in a policy 122). In response to the input breaching the hand-in threshold, the PRANmon component 107 select an action 124 of capturing additional information to help analyze the scenario better. For example, the PRANmon component 107 in the target eNB 100D can communicate this intent to all the protocol components and set an alert to track all incoming hand-in requests. Optionally, the action 124 can also further narrow the problem down to a specific neighbor sector, and/or PCI. This action 124 triggers the further flow of steps as described in the control-msg example illustrated in FIG. 6.

For example, in step T0, the PRANmon component 107 can receive an incoming handover request, e.g., in an info-capsule (with UE-ID allocation) from the RRM component.

In step T1, the PRANmon component 107 triggers snooping to be turned on for a specific UE-ID (or group of UE-IDs) and enables RRC, RRM, and/or S1AP-level logging to be enhanced for the same.

Once an RNTI and/or dedicated preamble is allocated to the target eNB 100D, the PRANmon component 107 triggers the FAPI-snooping and requests RRC, RLC, and/or L2 components to increase the logging level for that UE/RNTI in step T2.

In step T3, the PRANmon component 107 keeps monitoring the messages and once the handover steps are completed (step T2 is completed), it informs the RRC, RRM, RLC, and/or L2 components to stop or decrease the logging for the specific UE/RNTI once hand-in is completed.

If for some reason, the PRANmon component 107 encounters errors, then it keeps collecting debug log/data and after a pre-configured period (e.g., 5 seconds); then automatically reconfigures all components in the target eNB 100D to reduce/lower the logging level; and stops snooping on different messaging layers in step T4.

Thus, the PRANmon component 107 can help to collect various logs that are related to hand-in in order to (1) identify success and failure scenarios; and (2) produce a valuable debug capsule (e.g., data) to quickly diagnose and resolve the problem.

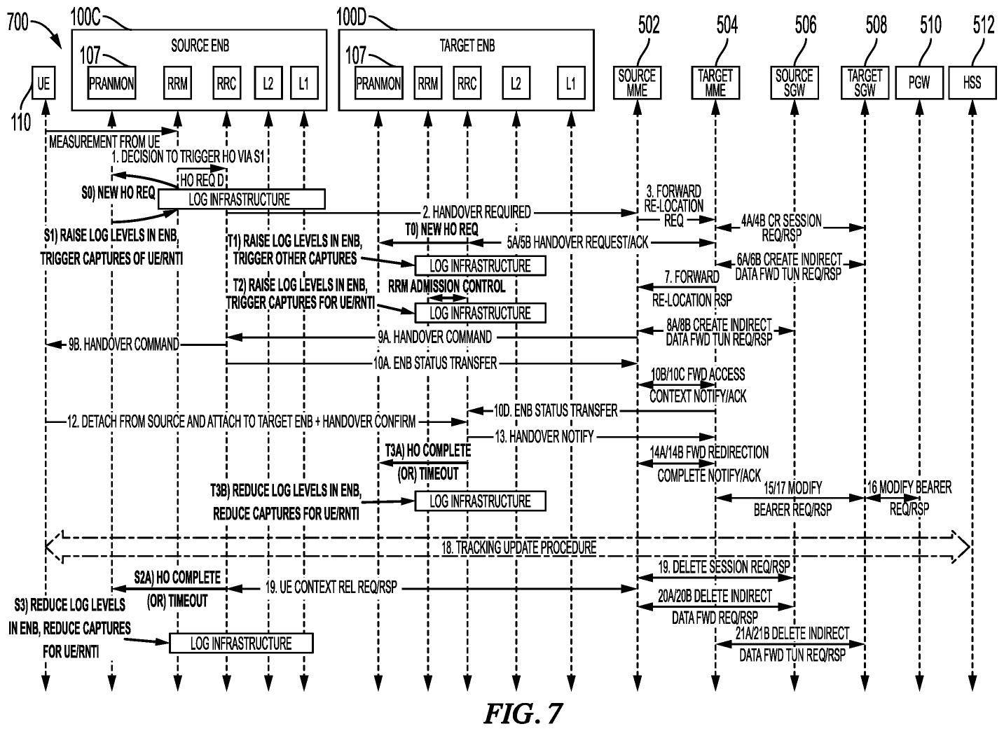

FIG. 7 is an additional sequence diagram 700 illustrating various points where additional action could be taken by a source eNB 100C to debug hand-in failures. FIG. 7 illustrates the same system as in FIG. 5, but with more component-level detail. FIG. 7 also includes the “T” steps of FIG. 6. Therefore, where a particular step in FIG. 7 includes the same number as a step in FIGS. 5 and/or 6, it refers to the same step. In other words, Fi FIG. 7 may illustrate only a subset of the steps from FIG. 5, although it is understood that FIG. 7 may include all the steps of FIGS. 5 and 6 (with the addition of the “S” steps that aren't in FIG. 5 or 6). The steps beginning with “S” (in bold type in FIG. 7) are steps involving the PRANmon component 107 in the source eNB 100C.

Continuing with the hand-in debugging scenarios of FIGS. 5-6, assume that source eNB 100C is encountering high hand-out failures to target eNB 100D, which breach a hand-out threshold. For example, the hand-out failures may be input 120 to a trigger (in a policy 122). In response to the input breaching the hand-out threshold, one or more actions 124 may be taken, described below. Accordingly, FIG. 7 illustrates steps taken at the PRANmon component 107 in the source eNB 100C.

In step S0, following a handover trigger decision being made (in step 1), the PRANmon component 107 in the source eNB 100C may receive a new handover message, e.g., from the RRC component of the source eNB 100C.

In step S1, the PRANmon component 107 in the source eNB 100C enables the gathering of higher-level debug-information (e.g., raising the UE/RNTI specific log-levels) in response to the new handover message. In parallel, handover steps are attempted, and messages are tracked.

Later in step S2, upon successful/failed handover/timeouts (in step 19b), the PRANmon component 107 reduces (less-frequent collection) the UE/RNTI specific log-levels at the source eNB 100C to normal (pre-S1) levels, and the logs capsule stored for offline analysis.

Thus, the debug information available from both source eNB 100C (“S” steps) and target eNB 100D (“T” steps) can be useful to understand the UE 110 and/or C-RAN 100C-D behavior and identify the root-cause of any hand-in issues.

Even in the case of successful handovers, if there are cases where the UE 110 ping-pongs between the same set of eNBs, the PRANmon component 107 can identify such UEs and can initiate certain policy action(s) to deal with the scenario (e.g., power-adjustment of radios, threshold adjustments, or even simply avoiding tracking such UE 110 handovers for known failure scenarios). The detection of ping-ponging UEs 110 may serve as a different input to a separate policy 122 with its own triggers and actions 124.

Apart from X2, the PRANmon component 107 communication can provide some form of out-of-band channel to exchange UE-specific information, cell-specific information, and/or RU-specific information between the communicating eNBs. This type of input 120 from which peer eNBs can select policy-based action(s) 124. It can also be useful in debugging certain ping-pong handover scenarios, coverage holes, etc.

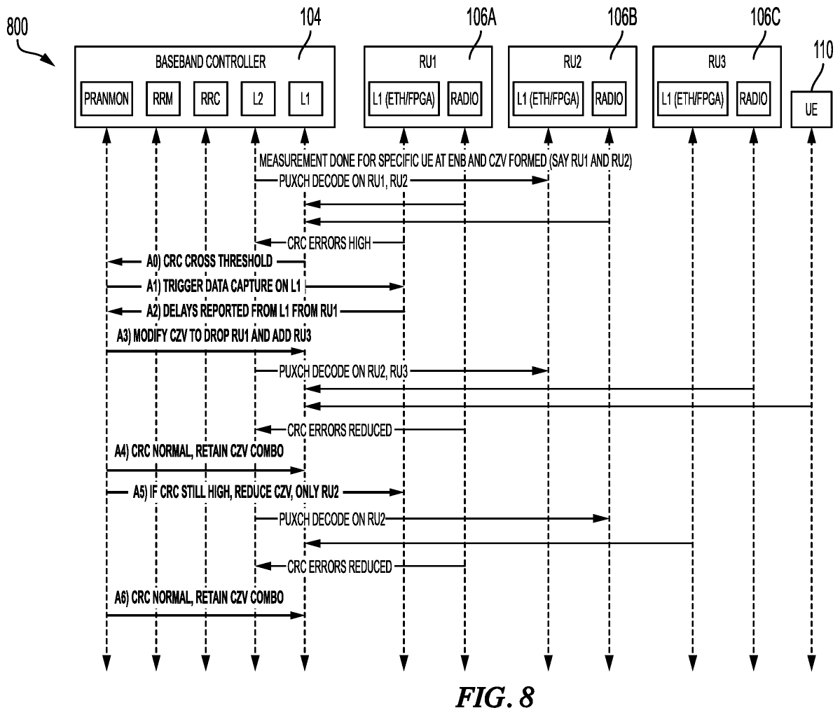

FIG. 8 is a sequence diagram 800 illustrating various points where additional action could be taken to debug system performance issues in the fronthaul network 116 (FH) of a C-RAN 100C-D. In the scenario of FIG. 8, the fronthaul 116 plays a large role in C-RAN 100C-D operation and its performance needs to be continuously monitored to provide reliable service. In a C-RAN implementing a 4G LTE air interface, the UE's 110 PUSCH I/Q information is captured in the RUs 106, quantized, and sent towards the baseband controller 104, at every symbol time. These PUSCH I/Q packets need to arrive at baseband controller 104 via various links, switches, and/or routers within a certain time to be taken up for processing at the baseband controller 104. When the PUSCH I/Q packets they arrive in time, the baseband controller 104 may perform full DMRS/PUSCH processing, which allows for successful decoding and CRC validation of the UE 110 packet. In FIG. 8, “PU×CH” refers to PUCCH or PUSCH.

However, if specific symbol packets of the uplink channel data arrive late or are dropped, this leads to CRC failures. And if these delays or drops continue for an extended period of time, this will impact the KPIs and could even affect UEs' 110 ability to attach to the C-RAN 100C-D. In the event of CRC failures, the UE 110 continues to do RACH again and again (with increasing power levels), which can cause decoding failures to persist or worsen. This scenario causes high degradation in RACH-to-connection ratio KPI (low percentage of RACH procedures culminate in attachment) and wastes RACH and PUSCH resources. This also causes high interference for other UEs 110 in the neighborhood.

However, if the eNB were able to adjust the RUs 106 used for uplink-combining, thereby varying (e.g., reducing) the front-haul load, the chances of msg3 decoding increases. Accordingly, a PRANmon component 107 may act as a multi-layer, context-aware tool in the baseband controller 104, 5G CU 103, or 5G DU 105 to trigger measurements at L1 and adjust configuration changes in L2 effectively in real-time, as described below. The steps beginning with “A” (in bold type in FIG. 8) are steps involving the PRANmon component 107 in the baseband controller 104, which could also be a 5G CU 103 or DU 105 in 5G configurations.

When high CRC errors for a specific UE 110 are measured by the central unit, which controls the RUs 106 (e.g., 106A, 106B, and 106C in FIG. 8) in the UE's uplink combining group and reported to the baseband controller 104. When CRC errors (input 120) exceeds a CRC threshold (in a trigger), Layer 1 and/or Layer 2 components of the baseband controller 104 can indicate this to the PRANmon component 107 in step A0.

In response, the PRANmon component 107 may set up measurements to trigger L1 data capture of measure drops and/or delays in step A1.

In response, the L1 component in the baseband controller 104 can inform the PRANmon component 107 about the details of such drops and/or delays in an RU-specific manner and give more details about the affected RNTIs in step A2. These additional measurements can be considered action(s) 124 and/or additional input for further trigger(s).

When the PRANmon component 107 receives an indication that the FH drops and/or delays are happening, the PRANmon component 107 can change the configurations by varying the UE's 110 uplink combining group (the RUs 106 that combine signals received from the UE 110) and alert the L2 scheduler in step A3.

Depending on further monitoring of the success or failure of the action taken, the uplink combining group (CZV) for that UE 110 may be maintained in step A4 until another change of the UE's 110 uplink combining group is triggered.

If the PRANmon component 107 determines that FH 116 drops and/or delays are happening, it can change the configurations such that FH 116 load can be minimized (e.g., by disabling uplink combining or reducing CZV thresholds to minimize the fronthaul 116 load) and alert the L2 scheduler of the changes in step A5.

Depending upon further monitoring of the success or failure of the action taken, the uplink combining group (CZV) for that UE 110 may be maintained in step A6 until another change of the UE's 110 uplink combining group is triggered.

Apart from self-adapting for the situation, the PRANmon component 107 in the baseband controller 104 can provide valuable debug information by doing sample captures at the exact time of the issue, in cooperation with the L1 component in the baseband controller 104. As some of the issues are rare and not easily reproducible in regular lab, this debugging data from such situations can be very useful for diagnosing problems in the network components and entities.

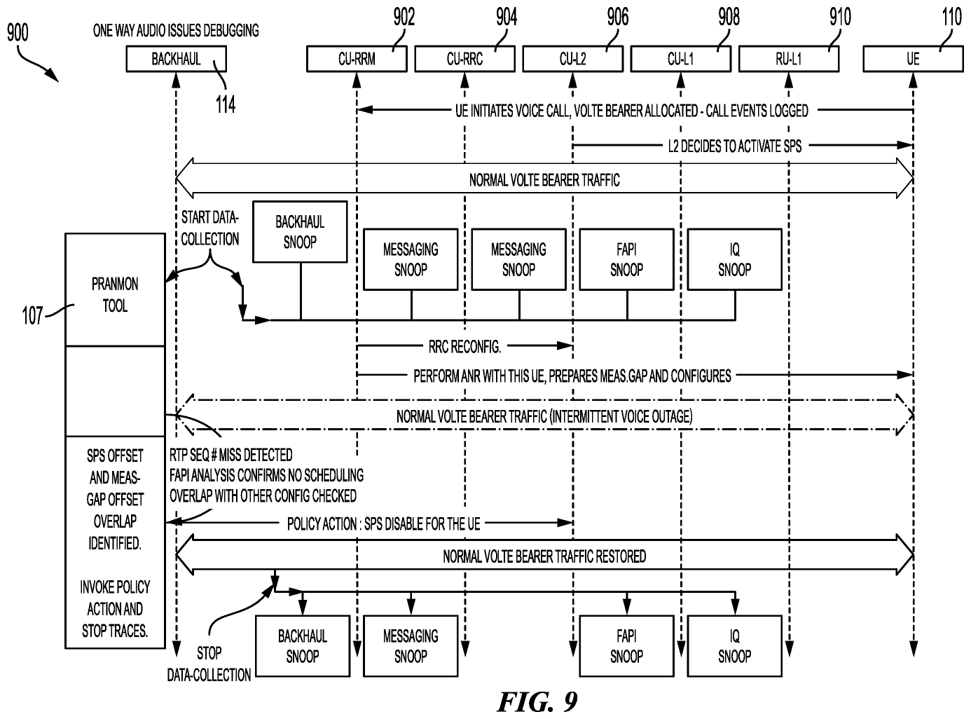

FIG. 9 is a sequence diagram 900 illustrating action that could be taken to debug semi-persistent scheduling (SPS) issues in a communication system (e.g., a C-RAN 100). Specifically, FIG. 9 illustrates the various components in a C-RAN 100 (CU-RRM 902, CU-RRC 904, CU-L2 906, CU-L1 908, and RU-L1 910) communicating with a UE 110 and a backhaul network 114. The CU-X components can be located in a baseband controller 104 if the C-RAN 100 is implementing an LTE air interface or in a 5G CU 103 or DU 105 if the C-RAN 100 is implementing a 5G air interface. RU-X components are located in an RU 106.

In the scenario of FIG. 9, the UE 110 is sending and receiving voice-over-LTE (VoLTE) and the C-RAN 100 is providing semi-persistent resources to the UE 110 using SPS scheduling. Since the voice-call traffic consumes a predictable load of a certain number of bytes every 20 or 40 ms, the semi-persistent allocation is preferred to avoid the load on the C-RAN's 100 scheduler. However the offset (the subframe number (SFN)/subframe (SF) time) provided to the UE 110 needs to be unique and it shouldn't overlap with other offset(s), such as the measurement-gap offset (SFN/SF time) provided to the UE.

In a measurement-gap, which occurs periodically every 6 ms for 40 ms or 80 ms, the UE 110 tunes away from the serving eNB (C-RAN 100) to measure neighboring cells or sectors (e.g., power of neighboring cells or sectors). If VoLTE SPS allocation happens at those same 6 ms intervals, then the UE 110 has no way to receive/transmit VoLTE transmissions.

A PRANmon component 107 in the central unit (e.g., baseband controller 104, 5G CU 103, 5G DU 105), RU(s) 106, and/or other network element (e.g., management system) can help identify the situation and help diagnose the situation so it can be avoided or corrected. For example, the PRANmon component 107 may initiate data collection, e.g., snooping backhaul data between the central unit and the backhaul network 114, messaging between CU-RRM 902 and CU-RRC 904, messaging between CU-RRC 904 and CU-L2 906, FAPI data between CU-L2 906 and the CU-L1 908, and/or I/Q data between the CU-L1 908 and the RU-L1 910.

In response to an interruption in VoLTE bearer traffic, the PRANmon component 107 may use this snooped data to determine the SPS offset and the measurement-gap offset for the UE 110. For example, the SPS offset is usually allocated by L2 and it is a specific subframe offset with repeating periodicity, e.g., SF=2 with periodicity of 20 ms (although other periodicities allowed, such as 40 ms, 80 ms, . . . 640 ns etc.). That means, the UE 110 should transmit and receive the SPS data on subframes at 22 ms, 42 ms, 62 ms, 82 ms, 102, 122 ms etc. The measurement gap offset is also configured on a per-UE 110 basis. Usually the gap is for a period of 6 ms starting at the subframe offset with repeating periodicity (of 40 ms/80 ms). For example, if the measurement gap offset SF=0 with periodicity of 40 ms is given to UE 110, then the UE 110 will be away from this cell (measuring neighbor cell signals) at 0-6 ms, then 40-46 ns, 80-86 ms etc. Therefore, when the UE 110 is doing measurement, it will be overlapping with the SPS-offset of 42, 82, 102 etc. and can't transmit/receive SPS data. And alternate SPS transmissions will see errors. When eNB is allocating a DL-SPS data, it will get a DTX (because the UE 110 sends neither ACK nor NACK). Similarly if the eNB is allocating a UL-SPS data, it will get CRC error (because the UE 110 didn't transmit anything because it is in measurement gap).

If the SPS offset and the measurement-gap offset overlap for the UE 110, the PRANmon component 107 may disable SPS for the UE 110. Once VoLTE bearer traffic resumes normally (uninterrupted), the PRANmon component 107 may stop the snooping described above.

Further Enhancements

A PRANmon component 107 also communicates with several other components (e.g., KPI-collection, alarm monitoring, switch stats monitoring) and can perform a wide variety of optimization and performance management functions autonomously using specific policy guidelines.

In general, this tool is described with C-RAN 100 network element system in context. However, the concepts and schemes are applicable for other product/components like 4G or 5G Citizens Broadband Radio Service (CBRS) eNBs, distributed antenna systems (DAS), etc.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. For example, where a computing device is described as performing an action, the computing device may carry out this action using at least one processor executing instructions stored on at least one memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### Terminology

Brief definitions of terms, abbreviations, and phrases used throughout this application are given below.

The term “determining” and its variants may include calculating, extracting, generating, computing, processing, deriving, modeling, investigating, looking up (e.g., looking up in a table, a database, or another data structure), ascertaining and the like. Also, “determining” may also include receiving (e.g., receiving information), accessing (e.g., accessing data in a memory) and the like. Also, “determining” may include resolving, selecting, choosing, establishing and the like.

The phrase “based on” does not mean “based only on,” unless expressly specified otherwise. In other words, the phrase “based on” describes both “based only on” and “based at least on”. Additionally, the term “and/or” means “and” or “or”. For example, “A and/or B” can mean “A”, “B”, or “A and B”. Additionally, “A, B, and/or C” can mean “A alone,” “B alone,” “C alone,” “A and B,” “A and C,” “B and C” or “A, B, and C.”

The terms “connected”, “coupled”, and “communicatively coupled” and related terms may refer to direct or indirect connections. If the specification states a component or feature “may,” “can,” “could,” or “might” be included or have a characteristic, that particular component or feature is not required to be included or have the characteristic.

The terms “responsive” or “in response to” may indicate that an action is performed completely or partially in response to another action. The term “module” refers to a functional component implemented in software, hardware, or firmware (or any combination thereof) component.

The methods disclosed herein comprise one or more steps or actions for achieving the described method. Unless a specific order of steps or actions is required for proper operation of the method that is being described, the order and/or use of specific steps and/or actions may be modified without departing from the scope of the claims.

In conclusion, the present disclosure provides novel systems, methods, and arrangements for data analysis and configuration of a C-RAN. While detailed descriptions of one or more configurations of the disclosure have been given above, various alternatives, modifications, and equivalents will be apparent to those skilled in the art without varying from the spirit of the disclosure. For example, while the configurations described above refer to particular features, functions, procedures, components, elements, and/or structures, the scope of this disclosure also includes configurations having different combinations of features, functions, procedures, components, elements, and/or structures, and configurations that do not include all of the described features, functions, procedures, components, elements, and/or structures. Accordingly, the scope of the present disclosure is intended to embrace all such alternatives, modifications, and variations as fall within the scope of the claims, together with all equivalents thereof. Therefore, the above description should not be taken as limiting.

### EXAMPLE EMBODIMENTS

Example 1 includes a distributed radio access network (RAN), comprising: a plurality of remote units (RUs), each being configured to exchange radio frequency (RF) signals with at least one user equipment (UE); a central unit communicatively coupled to the plurality of RUs via a fronthaul network comprising one or more ethernet switches; at least one processor located in the central unit, the RUs, or a combination thereof, wherein the at least one processor configured to: receive diagnostic information relating at least to processing performed for at least two layers of an air interface implemented by the distributed RAN; identify a system performance problem based on the diagnostic information using at least one policy; search for a cause of the system performance problem using at least a portion of the diagnostic information and at least one trigger in the at least one policy; and when the cause of the system performance problem is identified using the at least a portion of the diagnostic information, determine at least one action to correct, limit, or circumvent the system performance problem.

Example 2 includes the distributed RAN of Example 1, wherein the at least one processor is further configured to, when the cause of the system performance problem is not identified, identify and collect additional diagnostic information needed to identify the cause of the system performance problem.

Example 3 includes the distributed RAN of any of Examples 1-2, wherein the central unit is a Third Generation Partnership Project Fifth Generation (5G) Central Unit or Distributed Unit and the air interface is a 5G air interface.

Example 4 includes the distributed RAN of any of Examples 1-3, wherein the central unit is a baseband controller configured and the air interface is a Third Generation Partnership Project Long Term Evolution air interface.

Example 5 includes the distributed RAN of any of Examples 1-4, wherein the central unit is a head unit in a distributed antenna system.

Example 6 includes the distributed RAN of any of Examples 1-5, wherein the at least one action comprises at least one of the following: changing at least one parameter of the central unit, at least one of the RUs, at least one of the ethernet switches in the fronthaul network, or the at least one UE, or a combination thereof; power cycling, reinitializing at least one component of at least one of the RUs, at least one of the ethernet switches in the fronthaul network, or the central unit, or a combination thereof; changing RUs in a combining group for the at least one UE; deactivating one or more components of at least one of the RUs, at least one of the ethernet switches in the fronthaul network, or the central unit, or a combination thereof; changing a frequency at which the diagnostic information is collected; and sending a notification to an operator of the distributed RAN via a management system, wherein the notification indicates a problem that needs further action or analysis.

Example 7 includes the distributed RAN of any of Examples 1-6, wherein the diagnostic information is received from at least one of the RUs, at least one of the ethernet switches, the at least one UE, or a combination thereof.

Example 8 includes the distributed RAN of any of Examples 1-7, wherein the diagnostic information comprises any of the following: at least one metric used by a Layer-1 (L1) protocol; at least one metric used by a Layer-2 (L2) protocol; at least one metric used by a Layer-3 (L3) protocol; at least one metric related to an interface or tunnel used in the distributed RAN; or at least one metric related to CPU resources, memory resources, or other storage resources in any device within the distributed RAN.

Example 9 includes the distributed RAN of Example 8, wherein the at least one L1 protocol comprises processing relating to a Physical Downlink Control Channel (PDCCH), a Physical Downlink Shared Channel (PDSCH), a Physical Uplink Shared Channel (PUSCH), a Physical Uplink Control Channel (PUCCH), a Random Access Channel (RACH), or a Sounding Reference Signal (SRS); wherein the at least one L2 protocol comprises radio link control (RLC) or medium access control (MAC); and wherein the at least one L3 protocol comprises radio resource control (RRC), radio resource management (RRM), or self-organizing network (SON).

Example 10 includes the distributed RAN of any of Examples 1-9, wherein the diagnostic information comprises any of the following: at least one metric used by a control-plane protocol, comprising Stream Control Transmission Protocol (SCTP), S1 Application Protocol (S1AP) processing, and Internet Key Exchange (IKE); at least one metric used by a data-plane protocol, comprising GPRS Tunneling Protocol (GTP) and Selective Data Adaptive Protocol (SDAP); at least one metric used by Packet Data Convergence Protocol (PDCP) or IP security (IPSec) protocol; and at least one metric used by timing systems, comprising Global Positioning System (GPS), Precision Time Protocol (PTP), and Network Time Protocol (NTP); femto application platform interface (FAPI) messaging between a L2 component and a Layer-1 component in the central entity; in-phase, quadrature-phase (IQ) messaging between at least one of the RUs and the central entity; or debugging logs or other logs relating to communication between the central entity and the RUs.

Example 11 includes the distributed RAN of any of Examples 1-10, wherein the at least one processor is configured to identify a system performance problem using at least a portion of the diagnostic information and at least one threshold in the at least one policy.

Example 12 includes the distributed RAN of any of Examples 1-11, wherein the at least one processor is configured to search for the cause of the system performance problem using at least one trigger, in a set of hierarchical triggers, to identify the at least one action.

Example 13 includes the distributed RAN of any of Examples 1-12, wherein the at least one processor is configured to determine the at least one action using at least one trigger to correct, limit, or circumvent the system performance problem.

Example 14 includes a method performed by a distributed radio access network (RAN), the method comprising: receiving diagnostic information relating at least to processing performed for at least two layers of an air interface implemented by the distributed RAN; identifying a system performance problem based on the diagnostic information using at least one policy; searching for a cause of the system performance problem using at least a portion of the diagnostic information and at least one trigger in the at least one policy; and when the cause of the system performance problem is identified using the at least a portion of the diagnostic information, determining at least one action to correct, limit, or circumvent the system performance problem.

Example 15 includes the method of Example 14, further comprising, when the cause of the system performance problem is not identified, identifying and collecting additional diagnostic information needed to identify the cause of the system performance problem.

Example 16 includes the method of any of Examples 14-15, wherein the method is performed by a Third Generation Partnership Project Fifth Generation (5G) Central Unit or Distributed Unit and the air interface is a 5G air interface.

Example 17 includes the method of any of Examples 14-16, wherein the method is performed by a baseband controller configured and the air interface is a Third Generation Partnership Project Long Term Evolution air interface.

Example 18 includes the method of any of Examples 14-17, wherein the method is performed by a head unit in a distributed antenna system.

Example 19 includes the method of any of Examples 14-18, wherein the at least one action comprises at least one of the following: changing at least one parameter of a central unit in the distributed RAN, at least one remote unit (RU) in the distributed RAN, at least one of the ethernet switches in a fronthaul network of the distributed RAN, or the at least one UE, or a combination thereof; changing RUs in a combining group for the at least one UE; deactivating one or more components of at least one of the RUs, at least one of the ethernet switches in the fronthaul network, or the central unit, or a combination thereof; changing a frequency at which the diagnostic information is collected; and sending a notification to an operator of the distributed RAN via a management system, wherein the notification indicates a problem that needs further action or analysis.

Example 20 includes the method of any of Examples 14-19, wherein the diagnostic information is received from at least one RU in the distributed RAN, at least one ethernet switch in a distributed RAN, at least one UE attached to the distributed RAN, or a combination thereof.

Example 21 includes the method of any of Examples 14-20, wherein the diagnostic information comprises any of the following: at least one metric used by a Layer-1 (L1) protocol; at least one metric used by a Layer-2 (L2) protocol; at least one metric used by a Layer-3 (L3) protocol; at least one metric related to an interface or tunnel used in the distributed RAN; or at least one metric related to CPU resources, memory resources, or other storage resources in any device within the distributed RAN.

Example 22 includes the method of Example 21, wherein the diagnostic information comprises any of the following: wherein the at least one L1 protocol comprises processing relating to a Physical Downlink Control Channel (PDCCH), a Physical Downlink Shared Channel (PDSCH), a Physical Uplink Shared Channel (PUSCH), a Physical Uplink Control Channel (PUCCH), a Random Access Channel (RACH), or a Sounding Reference Signal (SRS); wherein the at least one L2 protocol comprises radio link control (RLC) or medium access control (MAC); wherein the at least one L3 protocol comprises radio resource control (RRC), radio resource management (RRM), or self-organizing network (SON).

Example 23 includes the method of any of Examples 14-22, wherein the diagnostic information comprises any of the following: at least one metric used by a control-plane protocol, comprising Stream Control Transmission Protocol (SCTP), S1 Application Protocol (S1AP) processing, and Internet Key Exchange (IKE); at least one metric used by a data-plane protocol, comprising GPRS Tunneling Protocol (GTP) and Selective Data Adaptive Protocol (SDAP); at least one metric used by Packet Data Convergence Protocol (PDCP) or IP security (IPSec) protocol; and at least one metric used by timing systems, comprising Global Positioning System (GPS), Precision Time Protocol (PTP), and Network Time Protocol (NTP); femto application platform interface (FAPI) messaging between a L2 component and a Layer-1 component in the central entity; in-phase, quadrature-phase (IQ) messaging between at least one of the RUs and the central entity; or debugging logs or other logs relating to communication between the central entity and the RUs.

Example 24 includes the method of any of Examples 14-23, wherein the identifying a system performance problem comprises using at least a portion of the diagnostic information and at least one threshold in the at least one policy.

Example 25 includes the method of any of Examples 14-24, wherein the searching for the cause of the system performance problem comprises using at least one trigger, in a set of hierarchical triggers, to identify the at least one action.

Example 26 includes the method of any of Examples 14-25, wherein the determining the at least one action comprises using at least one trigger to correct, limit, or circumvent the system performance problem.

1. A distributed radio access network (RAN), comprising:
a plurality of remote units (RUs), each being configured to exchange radio frequency (RF) signals with at least one user equipment (UE);
a central unit communicatively coupled to the plurality of RUs via a fronthaul network comprising one or more ethernet switches;
at least one processor located in the central unit, the RUs, or a combination thereof, wherein the at least one processor configured to:
receive diagnostic information relating at least to processing performed for at least two layers of an air interface implemented by the distributed RAN;
identify a system performance problem based on the diagnostic information using at least one policy;
search for a cause of the system performance problem using at least a portion of the diagnostic information and at least one trigger in the at least one policy; and
when the cause of the system performance problem is identified using the at least a portion of the diagnostic information, determine at least one action to correct, limit, or circumvent the system performance problem.

2. The distributed RAN of claim 1, wherein the at least one processor is further configured to, when the cause of the system performance problem is not identified, identify and collect additional diagnostic information needed to identify the cause of the system performance problem.

3. The distributed RAN of claim 1, wherein the central unit is a Third Generation Partnership Project Fifth Generation (5G) Central Unit or Distributed Unit, and the air interface is a 5G air interface.

4. The distributed RAN of claim 1, wherein the central unit is a baseband controller configured and the air interface is a Third Generation Partnership Project Long Term Evolution air interface.

5. The distributed RAN of claim 1, wherein the central unit is a head unit in a distributed antenna system.

6. The distributed RAN of claim 1, wherein the at least one action comprises at least one of the following:
changing at least one parameter of the central unit, at least one of the RUs, at least one of the ethernet switches in the fronthaul network, or the at least one UE, or a combination thereof;
power cycling, reinitializing at least one component of at least one of the RUs, at least one of the ethernet switches in the fronthaul network, or the central unit, or a combination thereof;
changing RUs in a combining group for the at least one UE;
deactivating one or more components of at least one of the RUs, at least one of the ethernet switches in the fronthaul network, or the central unit, or a combination thereof;
changing a frequency at which the diagnostic information is collected; and
sending a notification to an operator of the distributed RAN via a management system, wherein the notification indicates a problem that needs further action or analysis.

7. The distributed RAN of claim 1, wherein the diagnostic information is received from at least one of the RUs, at least one of the ethernet switches, the at least one UE, or a combination thereof.

8. The distributed RAN of claim 1, wherein the diagnostic information comprises any of the following:
at least one metric used by a Layer-1 (L1) protocol;
at least one metric used by a Layer-2 (L2) protocol;
at least one metric used by a Layer-3 (L3) protocol;
at least one metric related to an interface or tunnel used in the distributed RAN; or
at least one metric related to CPU resources, memory resources, or other storage resources in any device within the distributed RAN.

9. The distributed RAN of claim 8,
wherein the at least one L1 protocol comprises processing relating to a Physical Downlink Control Channel (PDCCH), a Physical Downlink Shared Channel (PDSCH), a Physical Uplink Shared Channel (PUSCH), a Physical Uplink Control Channel (PUCCH), a Random Access Channel (RACH), or a Sounding Reference Signal (SRS);
wherein the at least one L2 protocol comprises radio link control (RLC) or medium access control (MAC); and
wherein the at least one L3 protocol comprises radio resource control (RRC), radio resource management (RRM), or self-organizing network (SON).

10. The distributed RAN of claim 1, wherein the diagnostic information comprises any of the following:
at least one metric used by a control-plane protocol, comprising Stream Control Transmission Protocol (SCTP), S1 Application Protocol (S1AP) processing, and Internet Key Exchange (IKE);
at least one metric used by a data-plane protocol, comprising GPRS Tunneling Protocol (GTP) and Selective Data Adaptive Protocol (SDAP);
at least one metric used by Packet Data Convergence Protocol (PDCP) or IP security (IPSec) protocol; and
at least one metric used by timing systems, comprising Global Positioning System (GPS), Precision Time Protocol (PTP), and Network Time Protocol (NTP);
femto application platform interface (FAPI) messaging between a L2 component and a Layer-1 component in the central unit;
in-phase, quadrature-phase (IQ) messaging between at least one of the RUs and the central unit; or
debugging logs or other logs relating to communication between the central unit and the RUs.

11. The distributed RAN of claim 1, wherein the at least one processor is configured to identify a system performance problem using at least a portion of the diagnostic information and at least one threshold in the at least one policy.

12. The distributed RAN of claim 1, wherein the at least one processor is configured to search for the cause of the system performance problem using at least one trigger, in a set of hierarchical triggers, to identify the at least one action.

13. The distributed RAN of claim 1, wherein the at least one processor is configured to determine the at least one action using at least one trigger to correct, limit, or circumvent the system performance problem.

14. A method performed by a distributed radio access network (RAN), the method comprising:
receiving diagnostic information relating at least to processing performed for at least two layers of an air interface implemented by the distributed RAN;
identifying a system performance problem based on the diagnostic information using at least one policy;
searching for a cause of the system performance problem using at least a portion of the diagnostic information and at least one trigger in the at least one policy; and
when the cause of the system performance problem is identified using the at least a portion of the diagnostic information, determining at least one action to correct, limit, or circumvent the system performance problem.

15. The method of claim 14, further comprising, when the cause of the system performance problem is not identified, identifying and collecting additional diagnostic information needed to identify the cause of the system performance problem.

16. The method of claim 14, wherein the method is performed by a Third Generation Partnership Project Fifth Generation (5G) Central Unit or Distributed Unit, and the air interface is a 5G air interface.

17. The method of claim 14, wherein the method is performed by a baseband controller configured and the air interface is a Third Generation Partnership Project Long Term Evolution air interface.

18. The method of claim 14, wherein the method is performed by a head unit in a distributed antenna system.

19. The method of claim 14, wherein the at least one action comprises at least one of the following:
changing at least one parameter of a central unit in the distributed RAN, at least one remote unit (RU) in the distributed RAN, at least one of one or more ethernet switches in a fronthaul network of the distributed RAN, or the at least one UE, or a combination thereof;
power cycling, reinitializing at least one component of at least one of the RUs, at least one of the ethernet switches in the fronthaul network, or the central unit, or a combination thereof;
changing RUs in a combining group for the at least one UE;
deactivating one or more components of at least one of the RUs, at least one of the ethernet switches in the fronthaul network, or the central unit, or a combination thereof;
changing a frequency at which the diagnostic information is collected; and
sending a notification to an operator of the distributed RAN via a management system, wherein the notification indicates a problem that needs further action or analysis.

20. The method of claim 14, wherein the diagnostic information is received from at least one RU in the distributed RAN, at least one ethernet switch in a distributed RAN, at least one UE attached to the distributed RAN, or a combination thereof.

21. The method of claim 14, wherein the diagnostic information comprises any of the following:
at least one metric used by a Layer-1 (L1) protocol;
at least one metric used by a Layer-2 (L2) protocol;
at least one metric used by a Layer-3 (L3) protocol;
at least one metric related to an interface or tunnel used in the distributed RAN; or
at least one metric related to CPU resources, memory resources, or other storage resources in any device within the distributed RAN.

22. The method of claim 21, wherein the diagnostic information comprises any of the following:
wherein the at least one L1 protocol comprises processing relating to a Physical Downlink Control Channel (PDCCH), a Physical Downlink Shared Channel (PDSCH), a Physical Uplink Shared Channel (PUSCH), a Physical Uplink Control Channel (PUCCH), a Random Access Channel (RACH), or a Sounding Reference Signal (SRS)
wherein the at least one L2 protocol comprises radio link control (RLC) or medium access control (MAC);
wherein the at least one L3 protocol comprises radio resource control (RRC), radio resource management (RRM), or self-organizing network (SON).

23. The method of claim 14, wherein the diagnostic information comprises any of the following:
at least one metric used by a control-plane protocol, comprising Stream Control Transmission Protocol (SCTP), S1 Application Protocol (S1AP) processing, and Internet Key Exchange (IKE);
at least one metric used by a data-plane protocol, comprising GPRS Tunneling Protocol (GTP) and Selective Data Adaptive Protocol (SDAP);
at least one metric used by Packet Data Convergence Protocol (PDCP) or IP security (IPSec) protocol; and
at least one metric used by timing systems, comprising Global Positioning System (GPS), Precision Time Protocol (PTP), and Network Time Protocol (NTP);
femto application platform interface (FAPI) messaging between a L2 component and a Layer-1 component in the central unit;
in-phase, quadrature-phase (IQ) messaging between at least one of the RUs and the central unit; or
debugging logs or other logs relating to communication between the central unit and the RUs.

24. The method of claim 14, wherein the identifying a system performance problem comprises using at least a portion of the diagnostic information and at least one threshold in the at least one policy.

25. The method of claim 14, wherein the searching for the cause of the system performance problem comprises using at least one trigger, in a set of hierarchical triggers, to identify the at least one action.

26. The method of claim 14, wherein the determining the at least one action comprises using at least one trigger to correct, limit, or circumvent the system performance problem.
